(19) United States
(12) Patent Application Publication
(10) Pub. No.: US 2005/0159543 A1
(43) Pub. Date: Jul. 21, 2005

(54) Coating compositions, their preparation, and coated articles made therefrom

(75) Inventors: Ali Ersin Acar, Clifton Park, NY (US); Rainer Koeniger, Clifton Park, NY (US); Glen David Merfeld, Loudonville, NY (US)

Correspondence Address: General Electric Company;CRD Patent Docket Rm 4A59, Bldg. K-1, P.O. Box 8, Schenectady, NY, 12301, US

(73) Assignee: General Electric Company

(21) Appl. No.: 10/819,524

(22) Filed: Apr. 6, 2004

Related U.S. Application Data
(60) Provisional application No. 60/538,081, filed on Jan. 17, 2004.

(51) Int. Cl. C08G 8/02

(52) U.S. Cl. 525/48

(57) ABSTRACT

A coating composition comprising components A, B and optionally C, wherein component A comprises at least one carboxy-terminated polyarylate. Component B is an organic species which can react with the terminal carboxy groups of component A, and component C is a catalyst or mixture of catalysts. The carboxy-terminated polyarylates are prepared by a solution polymerization method wherein a stoichiometric excess of a diacid chloride is reacted with a dihydroxy-substituted aromatic compound (e.g. resorcinol) in the presence of an organic base and a limited amount of water to produce an initially formed polyarylate comprising anhydride linkages. The initially formed polyarylate is then subjected to selective hydrolysis of the anhydride linkages to provide a low molecular weight carboxy-terminated polyarylate.

### RELATED APPLICATION

This application is a non-provisional application based upon provisional application Ser. No. 60/538,081 filed Jan. 17, 2004.

### BACKGROUND OF THE INVENTION

This invention relates to coating compositions comprising polyarylates, the methods of preparing polyarylates and coated articles prepared using the coating compositions of the present invention.

Modern commerce and technology frequently employ organic coatings to shield various sensitive substrates from the harmful effects of the environment. Many such coatings are limited by long-term color instability, a limitation which is evidenced by a yellowing of the organic coating over time. Yellowing due to a coating's constituent polymeric components may be caused by the action of ultraviolet (UV) radiation. Another frequently encountered problem with organic coatings based on polymeric materials is poor resistance of the coating to chemicals and solvents after its application. Coatings which are tough, chemically resistant and “weatherable” (i.e. resistant to the effects of sunlight and other environmental conditions) are highly prized and diligently sought after.

Generally it has been observed that there is a tradeoff between weatherability and toughness in the performance of the commercial coating compositions known in the art. One solution to this problem has been the combination of extremely tough epoxies with polyesters to provide coatings with improved weatherability. Similarly acrylates, which are known to exhibit good weatherabiliy, but poor toughness, have been combined with polyester resins to improve their toughness. Compositions containing polyoxymethylene resins and various additives to improve toughness or impact strength are also known.

Certain types of polyarylates, known for their good weatherability and chemical resistance, have been found in the instant invention to be useful in the preparation of novel coating compositions having excellent chemical resistance and other properties. Up to the present, polyarylates useful in the preparation of novel coating compositions have been limited to hydroxy-terminated polyarylates. Hydroxy-terminated polyarylates have been prepared under interfacial reaction conditions, and most recently under homogeneous reaction conditions. U.S. patent application Ser. No. 10/676,892, which is incorporated herein by reference, discloses an efficient method for the preparation of hydroxy-terminated polyarylates under homogeneous reaction conditions. Despite recent strides in the preparation of hydroxy-terminated polyarylates under interfacial and homogeneous reaction conditions, it would nonetheless be highly desirable to provide polyarylates incorporating reactive functional groups other than terminal hydroxy groups for use in the preparation of novel materials.

Further, it remains of interest, to develop additional novel coating compositions that demonstrate scratch resistance, toughness, chemical resistance and weatherability, suitable for application over various types of substrates in a wide variety of applications. There is also a need for new synthetic methodology to prepare polymers comprising resorcinol chain members, having controlled molecular weight and which incorporate terminal functional groups other than hydroxy groups. The instant invention addresses these and other challenges and provides new and highly efficient solutions to them.

### BRIEF SUMMARY OF THE INVENTION

In one aspect, the present invention provides a coating composition comprising components A, B and optionally C:
(i) component A comprising at least one polyarylate, said polyarylate comprising structural units having formula I 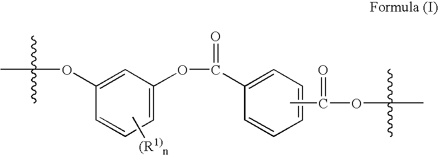
   wherein R¹ is independently at each occurrence a C₁-C₁₂ alkyl radical and n is 0-3, said polyarylate further comprising terminal carboxy groups;
(ii) component B comprising at least one “organic species” comprising one or more functional groups, said functional groups being chemically reactive with the terminal carboxy groups of the polyarylate of component A; and optionally
(iii) component C one or more catalysts which promote chemical reaction between the polyarylate terminal carboxy groups of component A and the “organic species” of component B.

In another aspect, the present invention provides powder coatings comprising at least one polyarylate, said polyarylate comprising structural units having formula I. In yet another aspect, the present invention provides a method for preparing polyarylates comprising structural units having formula I. In still another aspect, the present invention provides a coated article comprising a coating layer prepared from the coating composition of the invention. In yet another aspect the present invention provides novel carboxy-terminated polyarylate compositions. In yet another aspect the present invention provides novel anhydride-containing polyarylates which may be converted via hydrolysis into said novel carboxy-terminated polyarylates.

### DETAILED DESCRIPTION OF THE INVENTION

The present invention may be understood more readily by reference to the following detailed description of preferred embodiments of the invention and the examples included therein. In the following specification and the claims which follow, reference will be made to a number of terms which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “aliphatic radical” refers to a radical having a valence of at least one and consisting of a linear or branched array of atoms which is not cyclic. The array may include heteroatoms such as nitrogen, silicon, sulfur and oxygen or may be composed exclusively of carbon and hydrogen. Examples of aliphatic radicals include methyl, methylene, ethyl, ethylene, hexyl, hexamethylene, methoxy, ethoxy, thiomethyl, thioethyl, —(OSiMe₂)₁₀—, —(OSiMe₂)₅₀— and the like.

As used herein the term “cycloaliphatic radical” refers to a radical having a valance of at least one and comprising an array of atoms which is cyclic but which is not aromatic, and which does not further comprise an aromatic ring. The array may include heteroatoms such as nitrogen, sulfur and oxygen or may be composed exclusively of carbon and hydrogen. Examples of cycloaliphatic radicals include cyclopropyl, cyclopentyl cyclohexyl, 2-cyclohexylethy-1-yl, tetrahydrofuranyl and the like.

As used herein the term “aromatic radical” refers to a radical having a valence of at least one and comprising at least one aromatic ring. Examples of aromatic radicals include phenyl, pyridyl, furanyl, thienyl, naphthyl, phenylene, and biphenyl. The term includes groups containing both aromatic and aliphatic components, for example a benzyl group, a phenethyl group or a naphthylmethyl group. The term also includes groups comprising both aromatic and cycloaliphatic groups for example 4-cyclopropylphenyl and 1,2,3,4-tetrahydronaphthalen-1-yl.

As noted, the present invention provides a coating composition comprising components A, B and optionally C, wherein component A comprises at least one carboxy-terminated polyarylate having structural units of formula I, component B is an organic species which can react with the carboxy terminal groups of component A, and component C is a catalyst or mixture of catalysts.

Typically component A comprises a carboxy-terminated polyarylate comprising arylate polyester chain members. Said chain members comprise at least one dihydroxy-substituted aromatic hydrocarbon moiety in combination with at least one aromatic dicarboxylic acid moiety. In one particular embodiment the dihydroxy-substituted aromatic hydrocarbon moiety is derived from a 1,3-dihydroxybenzene moiety, illustrated in the structural moiety of formula (II), commonly referred to throughout this specification as resorcinol or a resorcinol moiety. In formula (II), R² is at least one of C₁-C₁₂ alkyl or halogen, and n is 0-3. The term “resorcinol” or “resorcinol moiety” as used within the context of the present invention should be understood to include both unsubstituted 1,3-dihydroxybenzene and substituted 1,3-dihydroxybenzenes unless explicitly stated otherwise. The concentration of component A of formula I, in the coating composition is in the range of about 1 to about 99 percent by weight of the coating composition. In one embodiment, the concentration of structural units of formula II in component A is in a range between about 0.01 and about 50 percent by weight of the total weight of the coating composition. In another embodiment, the concentration of structural units of formula II in component A is in a range between about 0.1 and about 20 percent by weight of the total weight of the coating composition. In yet another embodiment the concentration of structural units II in component A is in a range between about 0.1 and about 10 percent by weight of the total weight of the coating composition.

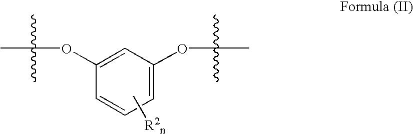

Suitable dicarboxylic acid residues include aromatic dicarboxylic acid residues derived from monocyclic moieties, including isophthalic acid, terephthalic acid, or mixtures of isophthalic and terephthalic acids, or from polycyclic moieties. In various embodiments, the aromatic dicarboxylic acid residues are derived from mixtures of isophthalic and terephthalic acids as typically illustrated in the structural moiety of formula (III).

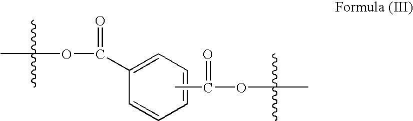

Therefore, in one particular embodiment, the present invention provides coating compositions comprising carboxy-terminated polyarylates, said polyarylates comprising resorcinol-arylate polyester chain members as typically illustrated in the structural moiety of formula (I) wherein R¹ and n are as previously defined.

The carboxy-terminated polyarylates present in component A may be prepared as disclosed herein via the reaction in an inert solvent of at least one dihydroxy aromatic compound with a stoichiometric excess of at least one diacid chloride in the presence of an organic base and sufficient water to produce at least one anhydride linkage in the product polyarylate.

In earlier studies it was found that control of the molecular weight during the preparation of hydroxy-terminated polyarylates was difficult to achieve. In the absence of a chain-stopper, the molecular weight of a hydroxy-terminated polyarylate produced interfacially by reaction of a dihydroxy-substituted aromatic compound with a diacid chloride is relatively insensitive to stoichiometric control. This is particularly true when the dihydroxy-substituted aromatic compound and its salts are highly insoluble in the solvent forming the organic phase of the interfacial reaction mixture. Earlier attempts to control polyarylate molecular weight led to the discovery that by increasing the molar ratio of the dihydroxy-substituted aromatic compound to the diacid chloride employed, and by decreasing the amount of water present in the interfacial reaction of the dihydroxy-substituted aromatic compound with the diacid chloride, enhanced control of the molecular weight of the hydroxy-terminated polyarylate could be achieved without the use of an end capping agent. A failure to control the molecular weight of the hydroxy-terminated polyarylate limits its utility in the preparation of coatings due to the higher glass transition temperatures (Tg) and lower concentration of hydroxyl end groups of the higher molecular weight hydroxy-terminated polyarylates relative to oligomeric hydroxy-terminated polyarylates.

In one aspect, the present invention provides a method for producing low molecular weight carboxy-terminated polyarylates which, because of their lower molecular weight, higher concentration of reactive carboxy groups, and lower glass transition temperature, are especially well suited for use in various coating applications.

It has been discovered within the context of the present invention that excellent control over the molecular weight of the carboxy-terminated polyarylate can achieved when the polyarylate is prepared in a reaction medium wherein the organic reactants (in particular the dihydroxy-substituted aromatic compound) are fully soluble. Thus, in one aspect, the present invention provides a method for preparing carboxy-terminated polyarylates having low molecular weight in a process in which reaction of one or more dihydroxy-substituted aromatic hydrocarbon moieties with a stoichiometric excess of at least one dicarboxylic acid moiety is carried out under conditions which are essentially homogeneous with respect to the organic reactants.

The novel method disclosed herein is especially well suited for preparing low molecular weight carboxy-terminated polyarylates of widely varying molecular weights and having widely varying structural units. By “low molecular weight” it is meant that the polyarylate has a weight average molecular weight of 15,000 grams per mole or less as measured by gel permeation chromatography (GPC) using polystyrene (PS) molecular weight standards. For purposes of this disclosure, the terms “oligomeric polyarylate” and “low molecular weight polyarylate” are used interchangeably.

In one aspect, the present invention provides a method of preparing carboxy-terminated polyarylates. Thus, the method comprises contacting in a reaction mixture at least one dihydroxy-substituted aromatic compound, at least one organic base, and a stoichiometric excess of at least one dicarboxylic acid dichloride (for convenience referred to as a “diacid chloride”), in at least one inert organic solvent, in the presence of an amount of water sufficient to provide an “initially-formed polyarylate” comprising at least one anhydride linkage, and hydrolysis of the anhydride linkage present in the initially formed polyarylate affords the carboxy-terminated polyarylate.

In one aspect, the overall process is conveniently described in terms of four steps:
A first step (step a) in which are combined at least one dihydroxy-substituted aromatic hydrocarbon moiety (also referred to interchangeably as a “dihydroxy-substituted aromatic hydrocarbon compound” or a “dihydroxy-substituted aromatic hydrocarbon”); and at least one organic base in an inert organic solvent to form a mixture, said dihydroxy-substituted aromatic hydrocarbon moiety being substantially soluble in said mixture, said dihydroxy-substituted aromatic hydrocarbon being used in a molar amount;
A second step (step b) in which the mixture formed in step (a) is combined with at least one dicarboxylic acid dichloride in a molar amount such that the molar amount of the dihydroxy-substituted aromatic hydrocarbon in the mixture is stoichiometrically deficient relative to the total molar amount of dicarboxylic acid dichloride, to form a reaction mixture;
A third step (step c) comprising agitating the reaction mixture formed in step (b) in the presence of an amount of water sufficient to provide at least one anhydride linkage, to form a polyarylate comprising at least one anhydride linkage (referred to herein as “the initially formed polyarylate”); and
A fourth step (step d) in which the polyarylate comprising at least one anhydride linkage is subjected to hydrolytic conditions under which the anhydride linkage is cleaved to produce a carboxy-terminated polyarylate.

In an alternate embodiment of the method of the present invention the first step (step a above) comprises combining at least one dihydroxy-substituted aromatic hydrocarbon moiety and optionally one or more dihydroxy-substituted aliphatic moieties, and at least one organic base in an inert organic solvent to form a mixture, said dihydroxy-substituted aromatic hydrocarbon moiety being substantially soluble in said mixture, said dihydroxy-substituted aromatic hydrocarbon and said optional dihydroxy-substituted aliphatic moiety being used in a molar amount.

In yet another embodiment of the method of the present invention the first step (step a above) comprises preparing a plurality of mixtures which are then added to a reaction mixture. Example 31 of the experimental section below illustrates an example of such an embodiment.

In the first step, at least one dihydroxy-substituted aromatic hydrocarbon moiety is mixed with at least one organic base in at least one inert organic solvent to form a mixture. Typically, the mixture comprising the dihydroxy-substituted aromatic hydrocarbon moiety, the organic base, and the inert organic solvent is substantially homogeneous. In the context of the mixture formed by the dihydroxy-substituted aromatic hydrocarbon moiety, the organic base, and the inert organic solvent “substantially homogeneous” means that at least about 50 percent, preferably at least about 75 percent, and still more preferably at least about 90 percent of the dihydroxy-substituted aromatic hydrocarbon moiety is dissolved in the organic solvent.

Suitable dihydroxy-substituted aromatic hydrocarbons for preparing carboxy-terminated polyarylates include those represented by the formula (IV)
HO-D-OH (IV)
wherein D is a divalent aromatic radical. In some embodiments D has the structure of formula (V); 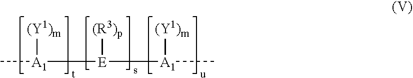
wherein each A¹ independently represents an aromatic group such as phenylene, biphenylene, naphthylene, and the like. E may be an alkylene or alkylidene group such as methylene, ethylene, ethylidene, propylene, propylidene, isopropylidene, butylene, butylidene, isobutylidene, amylene, amylidene, isoamylidene, and the like. Where E is an alkylene or alkylidene group, it may also consist of two or more alkylene or alkylidene groups connected by a moiety different from alkylene or alkylidene, such as an aromatic linkage; a tertiary amino linkage; an ether linkage; a carbonyl linkage; a silicon-containing linkage; or a sulfur-containing linkage such as sulfide, sulfoxide, sulfone, and the like; or a phosphorus-containing linkage such as phosphinyl, phosphonyl, and the like. In addition, E may be a cycloaliphatic group (e.g., cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, etc.); a sulfur-containing linkage, such as sulfide, sulfoxide or sulfone; a phosphorus-containing linkage, such as phosphinyl, phosphonyl; an ether linkage; a carbonyl group; a tertiary nitrogen group; or a silicon-containing linkage, for example silicon-containing linkages comprising silane, siloxy, or polydimethylsiloxane moieties. R³ is independently at each occurrence a monovalent hydrocarbon group such as alkyl, aryl, aralkyl, alkaryl, or cycloalkyl. Y¹ is independently at each occurrence an inorganic atom such as halogen (fluorine, bromine, chlorine, iodine); an inorganic group such as nitro; an organic group such as alkenyl, allyl, or R³ above, or an oxy group such as OR. The letter “m” represents any integer from and including zero through the number of positions on Al available for substitution; “p” represents an integer from and including zero through the number of positions on E available for substitution; “t” represents an integer equal to at least one; “s” is either zero or one; and “u” represents any integer including zero.

In the dihydroxy-substituted aromatic hydrocarbon compound in which D is represented by formula (V) above, when more than one Y¹ substituent is present, they may be the same or different. The same holds true for the R³ substituent. Where “s” is zero in formula (V) and “u” is not zero, the aromatic groups A¹ are directly joined with no intervening alkylidene or other bridge. The positions of the hydroxyl groups and Y¹ on the aromatic groups A¹ can be varied in the ortho, meta, or para positions with respect to the positions of the hydroxy groups (not shown in figure V but indicated by the dashed lines) and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” are each one; both aromatic groups A¹ are unsubstituted phenylene radicals; and E is an alkylidene group such as isopropylidene. In some particular embodiments both aromatic groups A¹ are p-phenylene, although both may be o- or m-phenylene or one o- or m-phenylene and the other p-phenylene.

Some illustrative, non-limiting examples of dihydroxy-substituted aromatic hydrocarbons represented by formula (V) include the dihydroxy-substituted aromatic hydrocarbons disclosed by name or formula (generic or specific) in U.S. Pat. No. 4,217,438. Some particular examples of dihydroxy-substituted aromatic hydrocarbons include 4,4′-(3,3,5-trimethylcyclohexylidene)diphenol; 4,4′-bis(3,5-dimethyl)diphenol; 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane (commonly known as bisphenol A); 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; 2,6-dihydroxy naphthalene; hydroquinone; resorcinol; and C₁-C₁₂ alkyl-substituted resorcinols.

The term “alkyl” as used in the various embodiments of the present invention is intended to designate both normal alkyl, branched alkyl, aralkyl, cycloalkyl, and bicycloalkyl radicals. In various embodiments, normal and branched alkyl radicals are those containing from 1 to about 12 carbon atoms, and include as illustrative non-limiting examples methyl, ethyl, n-propyl, isopropyl, n-butyl, sec-butyl, tertiary-butyl, pentyl, neopentyl, hexyl, heptyl, octyl, nonyl, decyl, undecyl and dodecyl. In various embodiments cycloalkyl radicals are those containing from 3 to about 12 ring carbon atoms. Some illustrative non-limiting examples of these cycloalkyl radicals include cyclobutyl, cyclopentyl, cyclohexyl, methylcyclohexyl, and cycloheptyl. In various embodiments aralkyl radicals (also defined herein as “aromatic radicals”) are those containing from 7 to about 14 carbon atoms; these include, but are not limited to, benzyl, phenylbutyl, phenylpropyl, and phenylethyl. In various embodiments aryl radicals (also defined herein as “aromatic radicals”) used in the various embodiments of the present invention are those containing from 6 to 18 ring carbon atoms. Some illustrative non-limiting examples of these aryl radicals include phenyl, biphenyl, and naphthyl.

In one embodiment of the present invention, the dihydroxy-substituted aromatic hydrocarbon is a resorcinol moiety having formula VI wherein R² and n are defined as in structure II. 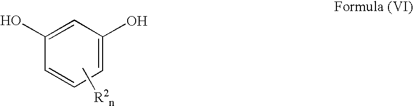
Alkyl groups, if present, are preferably straight-chain or branched alkyl groups, and are most often located in the position “ortho” to both oxygen atoms, although other ring locations are contemplated. Suitable C₁-C₁₂ alkyl groups include methyl, ethyl, n-propyl, isopropyl, butyl, iso-butyl, t-butyl, nonyl, and decyl, with methyl being particularly preferred. Suitable halogen groups are bromo, chloro, and fluoro groups. The value for n may be 0-3, preferably 0-2, and more preferably 0-1. A preferred resorcinol moiety is 2-methylresorcinol. The most preferred resorcinol moiety is an unsubstituted resorcinol moiety in which n is zero.

The organic base serves both to solubilize the dihydroxy-substituted aromatic moiety in the first step (step a) described above, to promote the polymerization reaction of the dihydroxy-substituted aromatic moiety and dicarboxylic acid dichloride in the third step (step c) described above, and to promote the hydrolysis of the anhydride linkage in the initially formed polyarylate in the fourth step (step d) described above. The organic base may be present in an amount corresponding to between about 0.9 and about 10, and preferably between about 0.9 to 2.5 equivalents relative to the diacid chloride. Suitable organic bases comprise tertiary organic amines.

Suitable tertiary organic amines are illustrated by triethylamine, tributylamine; N,N-dimethyl-N-butylamine; N,N-diisopropyl-N-ethylamine; N,N-diethyl-N-methylamine; 2,2,6,6-tetramethylpiperidine, and mixtures thereof. Additional examples of suitable tertiary amines include C₁-C₆ N-alkylpyrrolidines, such as N-ethylpyrrolidine; C₁-C₆ N-alkylpiperidines, such as N-ethylpiperidine, N-methylpiperidine, and N-isopropylpiperidine; C₁-C₆ N-alklymorpholines, such as N-methylmorpholine and N-isopropyl-morpholine; C₁-C₆ N-alkyldihydroindoles, C₁-C₆ N-alkyldihydroisoindoles, C₁-C₆ N-alkyltetrahydroquinolines, C₁-C₆ N-alkyltetrahydroisoquinolines, C₁-C₆ N-alkylbenzomorpholines, 1-azabicyclo-[3.3.0]-octane, quinuclidine, C₁-C₆ N-alkyl-2-azabicyclo[2.2.1]octanes, C₁-C₆ N-alkyl-2-azabicyclo[3.3.1]nonanes, and C₁-C₆ N-alkyl-3-azabicyclo[3.3.1]nonanes; N,N,N′,N′-tetraalkylalkylenediamines such as N,N,N′,N′-tetraethyl-1,6-hexanediamine. Particularly preferred tertiary amines are triethylamine and N-ethylpiperidine.

Additional agents which may also be added to both to solubilize the dihydroxy-substituted aromatic moiety, to promote the polymerization reaction of the dihydroxy-substituted aromatic moiety and dicarboxylic acid dichlorides, and to promote the hydrolysis of the anhydride linkage in the initially formed polyarylate include quaternary ammonium salts, quaternary phosphonium salts, and mixtures thereof.

Suitable quaternary ammonium salts include tetraethylammonium bromide, tetraethylammonium chloride, tetrapropylammonium bromide, tetrapropylammonium chloride, tetrabutylammonium bromide, tetrabutylammonium chloride, methyltributylammonium chloride, benzyltributylammonium chloride, benzyltriethylammonium chloride, benzyltrimethylammonium chloride, trioctylmethylammonium chloride, cetyldimethylbenzylammonium chloride, octyltriethylammonium bromide, decyltriethylammonium bromide, lauryltriethylammonium bromide, cetyltrimethylammonium bromide, cetyltriethylammonium bromide, N-laurylpyridinium chloride, N-laurylpyridinium bromide, N-heptylpyridinium bromide, tricaprylylmethylammonium chloride (sometimes known as ALIQUAT 336), methyl tri-C₈-C₁₀-alkyl-ammonium chloride (sometimes known as ADOGEN 464); and N,N,N′,N′,N′-pentaalkyl-alpha, omega-diammonium salts such as are disclosed in U.S. Pat. No. 5,821,322.

Suitable quaternary phosphonium salts are illustrated by tetrabutylphosphonium bromide, benzyltriphenylphosphonium chloride, triethyloctadecylphosphonium bromide, tetraphenylphosphonium bromide, triphenylmethylphosphonium bromide, trioctylethylphosphonium bromide, and cetyltriethylphosphonium bromide.

Suitable inert organic solvents used in the preparation of carboxy-terminated polyarylates according to the method of the present invention include halogenated aliphatic solvents, halogenated aromatic solvents, aliphatic ketone solvents, aliphatic ester solvents, aliphatic ether solvents, aromatic ether solvents, aliphatic amide solvents, aliphatic hydrocarbon solvents, and aromatic hydrocarbon solvents. The inert organic solvents may be used singly or as mixtures of solvents. Halogenated aliphatic solvents are illustrated by dichloromethane, chloroform, trichloroethylene, tetrachloroethane, 1,2-dichloroethane and the like. Halogenated aromatic solvents are illustrated by chlorobenzene, ortho-dichlorobenzene, fluorobenzene, chlorotoluene, chloroxylene, chloronaphthalene, and the like. Aliphatic ketone solvents are illustrated by acetone, 2-butanone, cyclohexanone, dihydroisophorone, dihydrophorone, and the like. Aliphatic ester solvents are illustrated by methyl acetate, ethyl acetate, propyl acetate, and the like. Aliphatic ether solvents are illustrated by diethyl ether, tetrahydrofuran, dioxane, and the like. Aromatic ether solvents are illustrated by anisole, diphenyl ether, and the like. Aliphatic amide solvents are illustrated by N,N-dimethylormaide; N,N-dimethyacetamide, N-methyl-2-pyrrolidinone, and the like. Aliphatic hydrocarbon solvents are illustrated hexane, cyclohexane, isooctane, and the like. Aromatic hydrocarbon solvents are illustrated by toluene, xylene, ethylbenzene, and the like. An especially preferred solvent is dichloromethane.

As noted, in the third step according to the method of the present invention used in the preparation of carboxy-terminated polyarylates, a reaction mixture comprising a stoichiometric excess of at least one dicarboxylic acid dichloride (diacid chloride) and the dihydroxy-substituted aromatic hydrocarbon are reacted in the presence of an organic base and least one inert organic solvent. There is also present in the reaction mixture an amount of water sufficient to produce a polyarylate comprising at least one anhydride linkage. The water may be added deliberately or in some instances simple be adventitious (See for example Example 14 in Table 1). Typically the amount of water present during the third step is in a range between about 0.001 moles and about 1 moles of water for every mole of diacid chloride present in the reaction mixture. In one embodiment the amount of water present during the third step is in a range between about 0.01 moles and about 0.5 moles of water for every mole of diacid chloride present in the reaction mixture. In another embodiment the amount of water present during the third step is in a range between about 0.01 moles and about 0.1 moles of water for every mole of diacid chloride present in the reaction mixture.

The diacid chlorides used according to the method of the present invention are principally aromatic diacid chlorides, however aliphatic diacid chlorides may also be employed. Suitable aromatic diacid chlorides are represented by monocyclic diacid chlorides, for example isophthaloyl dichloride, terephthaloyl dichloride, and mixtures of isophthaloyl and terephthaloyl dichlorides. Suitable polycyclic diacid chlorides include diphenyl dicarboxylic acid dichloride, diphenylether dicarboxylic acid dichloride, and naphthalenedicarboxylic acid dichloride. Naphthalene-2,6-dicarboxylic acid dichloride is a preferred polycyclic diacid chloride. As noted, mixtures of various diacid chlorides may be employed, for example mixtures of monocyclic and polycyclic aromatic dicarboxylic acid dichlorides. In one embodiment the dicarboxylic acid dichloride comprises a mixture of isophthaloyl and terephthaloyl dichlorides. The use of a mixture of isophthaloyl and terephthaloyl dichlorides is conveniently represented by Formula VII. 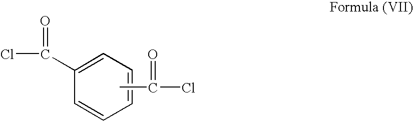
It should be noted that formula VII merely indicates that either or both of isophthaloyl and terephthaloyl dichlorides may be present. In preferred embodiments the dicarboxylic acid dichlorides comprise mixtures of isophthaloyl and terephthaloyl dichloride in a molar ratio of isophthaloyl to terephthaloyl dichloride of about 0.2-5:1 and preferably about 0.8-2.5:1. In one embodiment a triacid chloride may be included in the preparation of the carboxy-terminated polyarylate, wherein the carboxy-terminated polyarylate includes a branched structure. Typically the triacid chloride is used in an amount corresponding to between about 0.00001 moles and about 0.03 moles per mole of diacid chloride employed. Triacid chlorides are illustrated by 2, 3,5-benzenetricarboxylic acid trichloride and the like. It should be noted that branched carboxy-terminated polyarylates are also obtained if a polyol having three or more OH groups is included in the reaction mixture formed in the third step (step c) described above. Suitable polyols which may be used as branching agents include 1,3,5-trihydroxybenzene, 1, 1, 1,-tris(4-hydroxyphenyl)ethane, and the like.

In one embodiment the present invention provides a novel method for preparing a carboxy-terminated polyarylate wherein said carboxy-terminated polyarylate comprises structural units derived from at least one diol having structure IV and at least one aromatic diacid chloride, said carboxy-terminated polyarylate further comprising structural units (“chain members”) derived from aliphatic dicarboxylic acids and/or aliphatic diols. Structural units derived from aliphatic dicarboxylic acids and/or aliphatic diols are referred to herein as “soft-block” segments or simply “soft blocks”.

The term “soft-block” as used herein, indicates that some segments of these particular polymers are made from non-aromatic monomer units. Such non-aromatic monomer units are generally aliphatic and are known to impart flexibility to the soft-block-containing polymers. In one embodiment, a carboxy-terminated polyarylate may be prepared using the method of the present invention said carboxy-terminated polyarylate comprising structural units represented by formulae (II), (III), and (VIII): 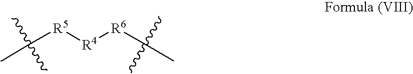
wherein R⁴ is a C₂-C₁₀₀₀₀ aliphatic radial, or a C₄-C₂₀ cycloaliphatic radical and R⁵ and R⁶ each independently represent a bond, 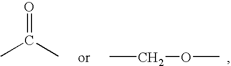
wherein the first (on left) of the two structures indicated represents a carbonyl group with two open positions for bond formation, and the second (on right) of the two structures represents an oxymethylene group with two open positions for bond formation. In various embodiments R⁴ is a C₂₋₂₀ straight chain alkylene radical, C₃₋₁₀ branched alkylene radical, C₄₋₁₀ cycloalkylene radical, or a C₇-C₂₀ bicycloalkylene radical. Still other embodiments provide a composition wherein R⁴ represents C₃₋₁₀ straight-chain alkylene or C₆-cycloalkylene. In one embodiment R⁴ represents a polysiloxane-containing moiety, for example —CH₂CH₂(OSiMe₂)₁₀CH₂CH₂—. In another embodiment R⁴ is a polylactone moiety. In yet another embodiment, R⁴ comprises structural units having formula (IX): 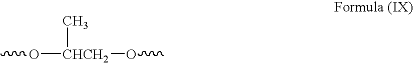
as in the case where the soft block comprises a polypropylene oxide residue. In still yet another embodiment, R⁴ comprises structural units having formula (X): 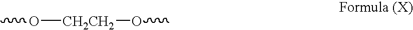
as in the case where the soft block comprises a polyethylene oxide residue. In various embodiments of carboxy-terminated polyarylates containing soft-block chain members, n in formula (II) is zero.

As noted, in one embodiment the soft block is derived from a diol derived from a polylactone. For example, the soft bock may comprise a hydroxy-terminated polylactone, for example polycaprolactone diol.

The concentration of the soft block units in the polyarylate chain is typically in a range between about 0.01% to about 70%, more preferably about 0.1% to about 20% and most preferably about 0.1% to about 10% by weight of the total weight of the carboxy-terminated polyarylate. In embodiments in which a coating composition comprises a carboxy-terminated polyarylate which incorporates a soft block, the concentration of the soft block expressed as a weight percent of the total weight of the coating composition is in a range between about 0.001 and about 50 percent. Thus, in one embodiment, a coating composition comprises a carboxy-terminated polyarylate which comprises a soft block represented by formula VIII wherein the concentration of the structural unit of formula VIII expressed as a weight percentage of the total weight of the coating composition is in a range between about 0.01 and about 50 percent by weight of the total weight of the coating composition.

Typically, once the dihydroxy-substituted aromatic hydrocarbon moiety, the organic base, the inert solvent, and the dicarboxylic acid dichloride, and sufficient water to provide at least one anhydride linkage are combined to form a reaction mixture, the reaction mixture is agitated under inert atmosphere until the reaction is complete. This stage of the reaction provides as a product a polyarylate which comprises one or more anhydride linkages, said polyarylate being referred to as “the initially formed polyarylate”. In one embodiment it is found advantageous to provide a nitrogen, or other inert gas atmosphere inside the reactor during the course of one or more of the first, second, third and fourth steps.

In one embodiment, ‘the initially formed polyarylate” produced in the third step has structure XI 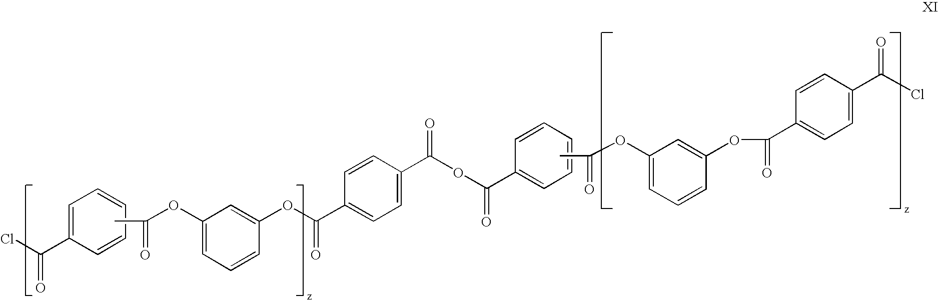
wherein z has an average value of about 10, and which when subjected to the hydrolytic conditions of the fourth step affords carboxy-terminated polyarylate having structure XII 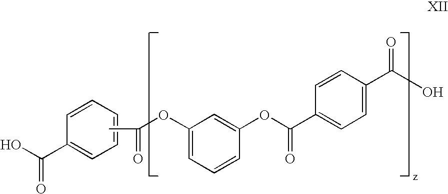
wherein z is defined as in structure XI.

Typically, the hydrolytic conditions employed in the fourth step (step d) described above, comprise subjecting the polyarylate comprising at least one anhydride linkage to contact with a large excess of water in the presence of an organic amine and inert solvent. This is typically carried out at a temperature in a range between about 0° C. and about 60° C. In one embodiment of the present invention the hydrolytic step is carried out at a temperature in a range between about 0° C. and about 40° C. In another embodiment of the present invention the hydrolytic step is carried out at a temperature in a range between about 15° C. and about 30° C. (i.e. ambient conditions).

The carboxy-terminated polyarylate may be isolated by the addition of sufficient acid to neutralize the remaining organic amine base present following the hydrolytic step. Neutralization can be effected using ether organic acids, for example trifluoroacetic acid, or inorganic acids, for example, hydrochloric acid. If the product carboxy-terminated polyarylate remains in solution in the inert solvent, the organic layer may be washed several times with water, and the product, carboxy-terminated polyarylate may be isolated by precipitation with an “antisolvent” (e.g. methanol) or the inert solvent may be removed by steam distillation or other conventional means. In some instances it is found that upon neutralization the product carboxy-terminated polyarylate precipitates. Thereafter, the product may be filtered and if need be washed or triturated to afford the carboxy-terminated polyarylate in highly pure form. Typically, the product carboxy-terminated polyarylate contains residual amounts of the diacid corresponding in structure to the diacid chloride. The product carboxy-terminated polyarylates may be freed from residual diacid contaminants using conventional purification means such as washing the product with dilute base and the like. When the diacid chloride employed is a mixture of iso- and terephthaloyl chloride, for example, the initially precipitated product carboxy-terminated polyarylate contains a mixture of isophthalic acid and terephthalic acid in an amount corresponding to between about 5 and about 10 weight percent based upon the total weight of the isolated polyarylate.

In order to characterize more reliably the product carboxy-terminated polyarylate, it is typically dried at elevated temperature for a period of 24 hours or so under vacuum prior to analysis by such techniques as NMR.

The carboxy-terminated polyarylate product prepared using the method described in the preceding sections may be characterized by Gel Permeation Chromatography (GPC) and Differential Scanning Calorimetry (DSC). Molecular weights determined by GPC are typically recorded as number average (Mₙ) molecular weight in grams per mole (g/mole) or weight average molecular weight (M_{w}) and are determined using polystyrene (PS) molecular weight standards. The molecular weights may also be determined by nuclear magnetic resonance (NMR). The weight average molecular weight of the carboxy-terminated polyarylate prepared by the method of the present invention is typically in a range between about 500 and about 14,000 grams per mole.

In one embodiment the coating composition of the present invention comprises a carboxy-terminated polyarylate having a weight average molecular weight in a range between about 500 and about 5000 grams per mole. In another embodiment the coating composition of the present invention comprises a carboxy-terminated polyarylate having a weight average molecular weight in a range between about 2000 and about 5000 grams per mole. In yet another embodiment the coating composition of the present invention comprises a carboxy-terminated polyarylate having a weight average molecular weight in a range between about 500 and about 2500 grams per mole.

As noted, in a primary aspect, the present invention provides a coating composition comprising components A, B and optionally C, wherein component A comprises at least one carboxy-terminated polyarylate having structural units of formula I, component B is an organic species which can react with the terminal carboxy groups of component A, and component C is a catalyst or mixture of catalysts which promote the reaction between components A and B. Component B comprises at least one organic species having one or more functional groups which may be the same or different, said functional groups being chemically reactive with the terminal carboxy groups of the polyarylate of component A. While any functional group capable of reaction with the terminal carboxy groups of the polyarylate of component A may be employed, the functional groups of component B are typically selected from the group consisting of isocyanates, epoxides, aliphatic esters, hydroxy groups and aromatic esters. In one embodiment, component B comprises an aliphatic polyisocyanate. In an alternate embodiment, component B comprises IPDI-Trimer (isocyanurate of isophorone diisocyanate, commercially known as VESTANAT T 1890). In yet another embodiment component B comprises one or more “blocked isocyanates”. A blocked isocyanate refers to a molecule which possesses at least one latent isocyanate functional group. For example, carbamates comprise one or more latent isocyanate groups. Typically upon heating, a carbamate fragments to form an alcohol and an isocyanate. An example of a blocked isocyanate is given here not by way of limitation but merely to further clarify the nature and meaning of the term blocked isocyanate. Thus, PhOCONH(CH₂)₆NHCOOPh, the carbamate formed by reaction of 2 moles phenol with 1 mole of 1,10-hexamethylenediiosocyanate, represents a “blocked isocyanate” which upon heating fragments to the starting phenol and diisocyanate. Various forms of blocked isocyanates are well known in the art. In another embodiment component B comprises epoxy resin precursor a polyglycidyl. In one embodiment component B comprises BPA diglycidyl ether (commercially known as EPON Resin 2002). Typically, the concentration of component B in the disclosed coating composition is in a range between about 1 and about 99 percent by weight of the total weight of the coating composition.

As noted, the coating composition may comprise a component C, a catalyst to promote the reaction between component A and component B. The presence or absence of component C is optional. Typically, the catalyst is selected from the group consisting of tertiary amines, quaternary ammonium salts, quaternary phosphonium salts, Lewis acids, and mixtures thereof. Typically, component C is present in an amount corresponding to between about 0.00001 and about 10 percent by weight of total weight the coating composition. In one embodiment benzyl trimethylammonium bromide (BTMAB) may be used as a catalyst.

The coating compositions of the present invention may contain one or more co-resins. The term “co-resin” is used to designate a polymeric species which does not fall within the class of materials belonging to the “organic species” of component B because the co-resin does not possess functional groups capable of reaction with the terminal carboxy groups of component A under conditions typically used for the formation of a coating. The co-resin may have either high or low molecular weight as defined herein. A high molecular weight co-resin is defined as having a weight average molecular weight of at least 15,000 grams per mole. A low molecular weight co-resin is defined as having a weight average molecular weight of less than 15,000 grams per mole. Polymers which are especially well suited for use as co-resins include polycarbonates, polyesters, polyetherimides, polyphenylene ethers, addition polymers and the like. Polyesters are illustrated by poly(alkylene arenedioates), especially poly(ethylene terephthalate) (hereinafter sometimes designated “PET”), poly(1,4-butylene terephthalate) (hereinafter sometimes designated “PBT”), poly(trimethylene terephthalate) (hereinafter sometimes designated “PTT”), poly(ethylene naphthalate) (hereinafter sometimes designated “PEN”), poly(butylene naphthalate) (hereinafter sometimes designated “PBN”), poly(cyclohexanedimethanol terephthalate), poly(cyclohexanedimethanol-co ethylene terephthalate) (hereinafter sometimes designated “PETG”), and poly(1,4-cyclohexanedimethyl-1,4-cyclohexanedicarboxylate) (hereinafter sometimes designated “PCCD”). The poly(alkylene arenedioates), poly(ethylene terephthalate) and poly(1,4-butylene terephthalate) are especially preferred in certain coating applications. Suitable addition polymers include homopolymers and copolymers, especially homopolymers of alkenylaromatic compounds, such as polystyrene, including syndiotactic polystyrene, and copolymers of alkenylaromatic compounds with ethylenically unsaturated nitriles, such as acrylonitrile and methacrylonitrile; dienes, such as butadiene and isoprene; and/or acrylic monomers, such as ethyl acrylate. These latter copolymers include the ABS (acrylonitrile-butadiene-styrene) and ASA (acrylonitrile-styrene alkyl acryl ate) copolymers. Addition polymers as used herein include polyacrylate homopolymers and copolymers including polymers comprising methacrylate-derived structural units.

The coating compositions disclosed herein may further comprise art-recognized additives including organic and inorganic pigments, dyes, impact modifiers, UV screeners, hindered amine light stabilizers, degassing agents, viscosity modifying agents, corrosion inhibitors, surface tension modifiers, surfactants, flame retardants, organic and inorganic fillers, stabilizers, and flow aids.

The coating compositions disclosed herein may be prepared through several routes. In some embodiments, the coating compositions may be prepared using an organic solvent base or water base. The coating compositions may also be prepared through a route, which is substantially solvent free, for example, in the form of a power coating.

The solvent based coating compositions comprising a polyarylate of formula I may be prepared through solution coating followed by evaporation. The solvent based coating formulations may be prepared and dissolved in suitable solvents for solvent casting. Typically dimethylacetamide and tetrahydrofuran or a mixture thereof are preferred solvents. However other co-solvents, such as amides (dimethylformamide, methylpyrolidone, etc), esters (ethyl acetate, butyl acetate, etc), ketones (acetone, methyl ethyl ketone, methyl iso-butyl ketone, etc), alcohols (methanol, ethanol, etc.) aromatics (toluene, xylene, etc.), halogenated solvents (dichloromethane, chloroform, etc.) and mixtures thereof may also be employed. The solutions of the coating compositions for solvent casting should be mixed thoroughly prior to film casting onto a substrate. The water based coating compositions have the coating compositions dispersed in the water phase.

The powder coating compositions comprising at least one polyarylate possessing structural units having formula I possess particularly advantageous physical properties for use in powder coatings when the polyarylate possessing structural units having formula I is an oligomeric polyarylate. As noted, polyarylates prepared using the novel synthetic procedure disclosed herein and which forms one aspect of the instant invention, typically have low molecular weights. It should be noted, that the novel process described in detail in preceding sections of this document may be used to prepare oligomeric polyarylates which are in some instances crystalline oligomeric polyarylates. In this respect, performance of dry powder coating formulations comprising oligomeric polyarylates may be enhanced when the polyarylates are in an amorphous rather than crystalline form. Thus in one embodiment, a crystalline oligomeric polyarylate is converted into an amorphous form for use in a coating formulation according to the present invention. In one embodiment, in order to suppress crystallinity, a crystalline oligomeric polyarylate is melt extruded in an extruder thereby producing an amorphous form of the oligomeric polyarylate.

Typically, the components of the powder coating compositions are ground to a powder for dry blending, dry blended to produce a blend. After dry blending, the blend is extruded, ground and sieved to prepare the powder coating formulation, which may be electrostatically deposited on the substrate to be coated to produce a coated substrate. Alternatively, the coating formulation may be “solvent cast”, or applied as a dispersion in water on a substrate to produce a coated substrate. The coated substrate may then be cured at a particular temperature for a certain time, or the coated substrate may be subjected to curing under a “cure profile” in which the cure conditions such as temperature, time and the like are varied during the curing process. The properties exhibited by the coating depend on the curing conditions. The optimum curing temperature and time ranges may be determined using the conditions disclosed herein or alternatively curing conditions may be arrived at by screening a modest number of different curing conditions.

The coating formulations disclosed herein have outstanding physical properties which include chemical resistance, hardness, toughness and weatherability. The chemical resistance, hardness, toughness and weatherability of the coatings prepared using the coating compositions disclosed herein are in many instances superior to coatings prepared using known coating formulations. In one aspect, the coatings prepared from the coating compositions of the present invention show enhanced photostability. Thus, when exposed to UV light, the polyarylate component of the subject coatings undergo photo-Fries reaction to generate hydroxybenzophenone structural units which serve to protect the coating from further photochemical reaction and degradation. The hydroxybenzophenone photoproducts effectively absorb light in the “near UV” range of the spectrum and enhanced photostability is conferred upon the coating thereby. In this manner it is believed that the coatings prepared using the coating compositions of the present invention produce coatings which exhibit enhanced more robust weatherability and increased toughness.

In another embodiment, the present invention comprises coated articles comprising a substrate layer comprising at least one thermoplastic polymer, thermoset polymer, cellulosic material, glass, ceramic, or metal, and at least one coating layer thereon, said coating layer prepared using the coating compositions of the instant invention, said coating layer comprising structural units having formula I. Optionally, the coated articles may further comprise an interlayer, for example an adhesive interlayer, between any substrate layer and any thermally stable polymer coating layer. Coated articles of the invention include, but are not limited to, those which comprise a substrate layer and a coating layer comprising oligomeric polyarylate; those which comprise a substrate layer with a coating layer comprising oligomeric polyarylate on each side of said substrate layer; and those which comprise a substrate layer and at least one coating layer comprising oligomeric polyarylate with at least one interlayer between a substrate layer and a coating layer.

The coated articles produced using the coating compositions of the present invention typically have outstanding initial gloss, improved initial color, weatherability, impact strength, and resistance to organic solvents encountered in their final applications.

The material of the substrate layer in the articles of this invention may be at least one thermoplastic polymer, whether addition or condensation prepared. Condensation polymers include, but are not limited to, polycarbonates, particularly aromatic polycarbonates, polyphenylene ethers, polyetherimides, polyesters (other than those employed for the coating layer, as defined hereinafter), and polyamides. Polycarbonates and polyesters are frequently preferred.

Polyester substrates include, but are not limited to, poly(ethylene terephthalate), poly(1,4-butylene terephthalate), poly(trimethylene terephthalate), poly(ethylene naphthalate), poly(butylene naphthalate), poly(cyclohexanedimethanol terephthalate), poly(cyclohexanedimethanol-co ethylene terephthalate), and poly(1,4-cyclohexanedimethyl-1,4-cyclohexanedicarboxylate).

Suitable addition polymer substrates include homo- and copolymeric aliphatic olefin and functionalized olefin polymers such as polyethylene, polypropylene, poly(vinyl chloride), poly(vinyl chloride-co-vinylidene chloride), poly(vinyl fluoride), poly(vinylidene fluoride), poly(vinyl acetate), poly(vinyl alcohol), poly(vinyl butyral), poly(acrylonitrile), acrylic polymers such as those of (meth)acrylamides or of alkyl (meth)acrylates such as poly(methyl methacrylate) (“PMMA”), and polymers of alkenylaromatic compounds such as polystyrenes, including syndiotactic polystyrene. The preferred addition polymers for many purposes are polystyrenes and especially the so-called ABS and ASA copolymers, which may contain thermoplastic, non-elastomeric styrene-acrylonitrile side chains grafted on an elastomeric base polymer of butadiene and alkyl acrylate, respectively.

Blends of any of the foregoing polymers may also be employed as substrates. Typical blends include, but are not limited to, those comprising PC/ABS, PC/ASA, PC/PBT, PC/PET, PC/polyetherimide, PC/polysulfone, polyester/polyetherimide, PMMA/acrylic rubber, polyphenylene ether-polystyrene, polyphenylene ether-polyamide or polyphenylene ether-polyester. Although the substrate layer may incorporate other thermoplastic polymers, the above-described polycarbonates and/or addition polymers still more preferably constitute the major proportion thereof.

The substrate layer in the coated articles of this invention may also comprise at least one of any thermoset polymer. Suitable thermoset polymer substrates include, but are not limited to, those derived from epoxies, cyanate esters, unsaturated polyesters, diallylphthalate, acrylics, alkyds, phenol-formaldehyde, novolacs, resoles, bismaleimides, PMR resins, melamine-formaldehyde, ureaformaldehyde, benzocyclobutanes, hydroxymethylfurans, and isocyanates. In one embodiment of the invention the thermoset polymer substrate further comprises at least one thermoplastic polymer, such as, but not limited to, polyphenylene ether, polyphenylene sulfide, polysulfone, polyetherimide, or polyester. Said thermoplastic polymer is typically combined with thermoset monomer mixture before curing of said thermoset. In one embodiment, the substrate layer comprises a layer of paint, such as a urethane-comprising paint or a melamine-based paint.

In one embodiment of the invention a thermoplastic or thermoset substrate layer also incorporates at least one filler and/or pigment. Illustrative extending and reinforcing fillers, and pigments include silicates, zeolites, titanium dioxide, stone powder, glass fibers or spheres, carbon fibers, carbon black, graphite, calcium carbonate, talc, mica, lithopone, zinc oxide, zirconium silicate, iron oxides, diatomaceous earth, calcium carbonate, magnesium oxide, chromic oxide, zirconium oxide, aluminum oxide, crushed quartz, calcined clay, talc, kaolin, asbestos, cellulose, wood flour, cork, cotton and synthetic textile fibers, especially reinforcing fillers such as glass fibers and carbon fibers, as well as colorants such as metal flakes, glass flakes and beads, ceramic particles, other polymer particles, dyes and pigments which may be organic, inorganic or organometallic. In another embodiment the invention encompasses coated articles comprising a filled thermoset substrate layer such as a sheet-molding compound (SMC).

The substrate layer may also comprise at least one cellulosic material including, but not limited to, wood, paper, cardboard, fiber board, particle board, plywood, construction paper, Kraft paper, cellulose nitrate, cellulose acetate butyrate, and like cellulosic-containing materials. The invention also encompasses blends of at least one cellulosic material and either at least one thermoset polymer (particularly an adhesive thermoset polymer), or at least one thermoplastic polymer (particularly a recycled thermoplastic polymer, such as PET or polycarbonate), or a mixture of at least one thermoset polymer and at least one thermoplastic polymer.

Coated articles encompassed by the invention also include those comprising at least one glass layer. Typically any glass layer is a substrate layer, although coated articles comprising a thermally stable polymer coating layer interposed between a glass layer and a substrate layer are also contemplated. Depending upon the nature of coating and glass layers, at least one adhesive interlayer may be beneficially employed between any glass layer and any thermally stable polymer coating layer. The adhesive interlayer may be transparent, opaque or translucent. For many applications it is preferred that the interlayer be optically transparent in nature and generally have a transmission of greater than about 60% and a haze value less than about 3% with no objectionable color.

Metal articles exposed to the environment may exhibit tarnishing, corrosion, or other detrimental phenomena. Therefore, in another embodiment the invention encompasses coated articles comprising at least one metal layer as substrate layer. Representative metal substrates include those comprising steel, aluminum, brass, copper, and other metals or metal-containing articles, which may require protection from the environment. Depending upon the nature of coating and metal layers, at least one adhesive interlayer may be beneficially employed between any metal layer and any thermally stable polymer coating layer.

The articles of this invention are characterized by the usual beneficial properties of the substrate layer, in addition to weatherability as evidenced by improved resistance to ultraviolet radiation and maintenance of gloss, and solvent resistance.

Coated articles which can be made which comprise thermally stable polymers comprising resorcinol arylate polyester chain members include automotive, truck, military vehicle, and motorcycle exterior and interior components, including panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; aluminum extrusions and facades; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications. The invention further contemplates additional fabrication operations on said articles, such as, but not limited to, molding, in-mold decoration, baking in a paint oven, lamination, and/or thermoforming.

As noted, in one aspect the present invention provides anhydride-containing polyarylates which may be converted via hydrolysis into novel carboxy-terminated polyarylate compositions. The novel anhydride-containing polyarylate compositions of the present invention typically comprise between about 0.01 and about 15, preferably between about 0.1 and 10, and still more preferably between about 1 and about 10 weight percent anhydride moieties based on the weight of the anhydride-containing polyarylate. The following calculations illustrate this concept for a polyarylate consisting of structural units derived from iso- and terephthalic acid moieties and resorcinol. In such a case the amount of anhydride linkages is calculated as shown below:
Formula Weight (FW) of anhydride linkage (3×16)+2×12=72 gram/mole
Formula Weight of polyarylate repeat unit=241 gram/mole
For an oligomeric polyarylate having 3-20 polyarylate repeat units (i.e. trimer-eicosamer) and a single anhydride linkage the anhydride content expressed as a weight percent of the polyarylate component is:
% weight of anhydride=72/(3×241)×100=11% (trimer)
% weight of anhydride=72/(4×241)×100=7.5% (tetramer)
% weight of anhydride=72/(5×241)×100=6% (pentamer)
% weight of anhydride=72/(10×241)×100=3% (decamer)
% weight of anhydride=72/(20×241)×100=1.5 (eicosamer)

In one embodiment the anhydride-containing polyarylate comprises structural units having formula I and has a weight average molecular weight (M_{w}) of less than about 10000 grams per mole. In an alternate embodiment the anhydride-containing polyarylate comprises structural units having formula I and has a weight average molecular weight (M_{w}) of less than about 5000 grams per mole. In yet another embodiment the anhydride-containing polyarylate comprises structural units having formula I and has a weight average molecular weight (M_{w}) of less than about 2500 grams per mole.

### EXAMPLES

The following examples are set forth to provide those of ordinary skill in the art with a detailed description of how the methods claimed herein are carried out and evaluated, and are not intended to limit the scope of what the inventors regard as their invention. Unless indicated otherwise, parts are by weight, temperature is in ° C.

Molecular weights are reported as weight average (M_{w}) molecular weight in grams per mole (g/mole) and were determined by gel permeation chromatography (GPC) using polystyrene (PS) molecular weight standards. Glass Transition Temperatures (Tg) of oligomeric polyarylates were measured by differential scanning calorimetry (DSC).

Chemical resistance of the coating was tested by methyl ethyl ketone (MEK) “double rub” technique. After curing, the coated substrates were allowed to cool to room temperature and remained under ambient conditions for at least 15 hours before being subjected to the methyl ethyl ketone (MEK) double rub or impact tests. MEK double rub tests (MEK DR) were performed under ambient conditions using a two-pound ballpein hammer as weight. The rounded head of the hammer was wrapped in six-layers of grade 10 cheesecloth and soaked with methyl ethyl ketone. The rounded head of the hammer was then placed on the coating and manually moved back and forth across the coating under its own weight. Each back and forth stroke was counted as 1 double rub. When the substrate became exposed the test was ended and the number of double rubs until substrate exposure was recorded. In cases in which the substrate did not become exposed, the tests were terminated after 200 double rubs. Thus, the actual number of MEK double rubs required to effect exposure of the substrate may be higher than the value of 200 recorded.

Impact tests were performed under ambient conditions using a slight variation of ASTM D5420-98a using a Gardner Impact Tester. Direct Impact (“DI”) values were recorded when the indentation test was carried out on the coated surface of the test part. Indirect Impact (“II”) values were recorded when the indentation test was carried out on the uncoated surface of the substrate. Only steel panels were used to determine the impact measurements.

The methods employed to synthesize carboxy-terminated polyarylates comprising structural units having formula I are described herein and form one aspect of the present invention. In previous studies, oligomeric hydroxy-terminated polyarylates comprising structural units having formula I, referred to for convenience sake as “hydroxy-terminated ITR oligomers”, were synthesized and shown to be useful in coatings applications. In the earlier work, it was found that control of the molecular weight of the product hydroxy-terminated polyarylate presented a major hurdle which had to be overcome in order to be able to prepare the relatively low molecular weight hydroxy-terminated ITR oligomers required for certain applications such as coatings. Additionally, it was earlier discovered that the uncontrolled formation of anhydride linkages during the preparation of product hydroxy-terminated polyarylates reduced the utility of said product hydroxy-terminated polyarylates owing to the instability of the anhydride linkages relative to ester linkages present in the polyarylates.

In the present invention, it has been discovered that oligomeric carboxy-terminated polyarylates may be prepared under certain reaction conditions which promote both the formation of anhydride linkages and their subsequent hydrolysis to terminal carboxy groups. The molecular weights of these “acid capped ITR oligomers” may be controlled by exercise of control of the relative amounts of resorcinol, diacid chloride, and water used. It has been discovered that for a given ratio of resorcinol to diacid chloride, the use of different amounts of water results in a change in the final molecular weight of the product carboxy-terminated polyarylate after the cleavage of the anhydride linkages (Compare Examples 2, 3, and 4 of Table 1). Molecular weights obtained after hydrolysis of the initially formed polyarylate are very similar to the molecular weight values obtained when the initially formed polyarylate is subjected to conditions (See “Amine Test”) which selectively effect aminolysis of the anhydride linkages present in the initially formed polyarylate. The Amine Test was developed earlier to detect residual anhydride linkages in hydroxy-terminated polyarylates. It is believed that under the conditions of the Amine Test no significant ester linkage cleavage occurs.

In the Amine Test an aliquot (approximately 1 mL) is taken from the reaction mixture (typically prior to hydrolysis). The aliquot is diluted with CHCl₃ and excess (50-200 microliters) diisobutylamine is added into the diluted aliquot. The secondary amine cleaves the internal anhydride linkages to form terminal amide and terminal carboxylate groups. The solution is stirred for approximately 2 to 3 minutes, and the amine test mixture is then quenched with 1N HCl and analyzed by GPC. Because the Amine Test results in the quantitative cleavage of all anhydride linkages, the molecular weights obtained upon subjecting the initially formed polyarylate to the Amine Test closely approximate those obtained following complete hydrolysis of the anhydride linkages present in the initially formed polyarylate.

TABLE 1
PREPARATION OF “ITR” POLYARYLATES COMPRISING
TERMINAL CARBOXY GROUPS^{a}

| | | | Polyarylate | | Polyarylate | | Polyarylate |
|---|---|---|---|---|---|---|---|
| | | | Mol. Wt | | Mol. Wt | | Mol. Wt |
| | | Resorcinol/diacid | Before | | After Amine | | After |
| | Sample | chloride/H₂0 | Hydrolysis | | Test | | Hydrolysis |
| Example | No. | Mole Ratios | M_{w}^{b} | Mₙ^{b} | M_{w}^{b} | Mₙ^{b} | M_{w}^{b} |
| Example 1 | EA204 | 0.272/0.327/0.0654 | 58641 | 16489 | 5263 | 1828 | 5041 |
| Example 2 | EA206 | 0.272/0.327/0.134 | 5737 | 3162 | 3872 | 1079 | 4140 |
| Example 3 | EA207 | 0.272/0.327/0.101 | 6283 | 3421 | 5455 | 2046 | — |
| Example 4 | EA208 | 0.272/0.327/0.134 | 4801 | 1673 | 4677 | 1321 | 4517 |
| Example 5 | EA209 | 0.236/0.327/0.134 | 5203 | 1916 | 2794 | 659 | 3060 |
| Example 6 | EA210 | 0.208/0.327/0.134 | 9531 | 4534 | 2029 | 744 | 1653 |
| Example 7 | EA211 | 0.208/0.327/0.134 | 9392 | 2800 | 1614 | — | 1652 |
| Example 8 | EA212 | 0.208/0.327/0.134 | 10963 | 4229 | 1761 | 341 | 1780 |
| Example 9 | EA213- | 0.208/0.327/0.134 | 11959 | 4823 | 1973 | 684 | 1754 |
| | S^{c} | | | | | | |
| Example | EA213- | 0.208/0.327/0.134 | 10171 | 5109 | 1832 | 442 | 1977 |
| 10 | C^{c} | | | | | | |
| Example | EA217 | 0.208/0.327/0.134 | 11460 | 5924 | 2075 | 1190 | 1883 |
| 11 | | | | | | | |
| Example | EA219 | 0.648/1.014/0.416 | 9641 | 3339 | 1985 | 728 | 2071 |
| 12 | | | | | | | |
| Example | EA223 | 16.35/25.61/10.5 | 5511 | 2749 | 1908 | 1049 | 1854 |
| 13 | | | | | | | |
| Example | E202 | 0.272/0.327/0 | 107216 | 11805 | 12505 | 2863 | 12418 |
| 14 | | | | | | | |

^{a}A 50/50 mixture of terephthaloyl chloride and isophthaloyl chloride was used for all reactions.
^{b}As measured by GPC.
^{c}From a total of 1 equivalent of diols (resorcinol + tetraethylene glycol). 0.2 equivalent of tetraethylene glycol was used as soft block.

The experimental data provided in Table 1 suggest that at a given ratio of resorcinol to diacid chloride, the presence of a larger amount of water gives rise to a higher concentration anhydride linkages in the initially formed polyarylate, which in turn provides a lower molecular weight carboxy-terminated polyarylate upon complete hydrolysis of the anhydride linkages present in the initially formed polyarylate. The molecular weight of the product carboxy-terminated polyarylate is also affected by the relative amounts of resorcinol and diacid chloride employed (See Examples 5, 6, and 7 of Table 1).

End group analysis of product carboxy-terminated polyarylates of Example 7 (EA210), Example 9 (EA212), Example 10 (EA213), and Example 13 (EA223) by 1H-NMR (in d₆-DMSO) revealed the complete absence of resorcinol end groups (i.e. hydroxy end groups), and only carboxylic acid (“carboxy”) end groups were detected. The absence of hydroxy end groups in the product polyarylates is compelling evidence that ester linkages present in the initially formed polyarylate do not undergo hydrolysis under the reaction conditions used to effect the hydrolysis of the anhydride linkages, because ester hydrolysis should give rise to both resorcinol and acid end groups. Thus both the amine test and the NMR results suggest that hydrolysis occurs only at anhydride linkages and the number of anhydride linkages present in the initially formed polyarylate controls the molecular weight of the product carboxy-terminated polyarylate.

### Examples 1-14

### Preparation of Oligomeric Carboxy-Terminated Polyarylates

### Example 1

### Sample EA204

To a 250 mL addition funnel was added resorcinol (30 g) and methylene chloride (100 mL). The heterogeneous mixture was degassed for 5 min with nitrogen and triethylamine (TEA, 114 mL) was added cautiously (Caution: This step was slightly exothermic). The mixture was then agitated for several minutes until a homogeneous solution was achieved.

A 3-neck, one liter glass reaction vessel equipped with a condenser, nitrogen inlet, mechanical stirrer and the addition funnel described above, was charged with a 1:1 mixture of iso- and terephthaloyl chloride (189.7 grams of 35% by weight solution of the 1:1 iso/tere mixture in methylene chloride) and methylene chloride solvent (180 mL). To the stirred solution was then added triethylamine (9.1 mL) in methylene chloride (100 mL). The resultant orange solution was stirred for about 1 minute (min.) and then water (1.17 mL) was added in two equal portions at 1 minute intervals. When the color of the resultant solution disappeared (1-2 min.) the resorcinol-TEA solution prepared above was added dropwise via the addition funnel over a period of about 25 minutes. Approximately 150 mL of additional methylene chloride was then added to dilute the reaction mixture, the viscosity of which was observed to increase during the addition of the resorcinol-TEA solution. The reaction mixture was then stirred under nitrogen for an additional 50 minutes and an aliquot was removed. A portion of the aliquot was analyzed directly by gel permeation chromatography (GPC), and a portion of this aliquot was subjected to the “Amine Test”(See description of the Amine Test above). This aliquot which represents the “initially formed polyarylate” (i.e. the polyarylate “before hydrolysis”) had a weight average molecular weight (M_{w}) of 58641 grams per mole and a number average molecular weight (Mₙ) of 16489 grams per mole. After removal of the aliquot, water (300 mL) was added to the reaction vessel to effect the quantitative hydrolysis of the anhydride linkages present in the initially formed polyarylate, and the resultant hydrolysis mixture was stirred for approximately two hours at ambient temperature. Aliquots were taken periodically and analyzed by GPC. When the molecular weight values obtained by GPC stabilized and approximated the molecular weights observed in the “Amine Test”, hydrolysis was discontinued. The stirred reaction mixture was quenched by the addition of sufficient 2N HCl to bring the pH of the aqueous layer to about 3. The product oligomeric carboxy-terminated polyarylate precipitated during the addition of the 2N HCl. The heterogeneous mixture was then stirred overnight, filtered and the solid product was washed with water until the washings were approximately pH 5. The product was found to contain about 6% by weight of a mixture of iso- and terephthalic acids. As determined by GPC, the product carboxy-terminated polyarylate had a weight average molecular weight (M_{w}) of 5041 grams per mole (Compare with M_{w}=5263 in the Amine Test). The product was purified (see procedure below) to remove residual iso- and terephthalic acid, and then dried in a vacuum oven at 75° C. for approximately two days prior to its use in a coating formulation.

### Example 2

### Sample EA206

A solution of resorcinol and triethylamine in methylene chloride was prepared using the same amounts as given in Example 1. The remainder of the experimental procedure was identical to Example 1 except that 18.2 mL of TEA (instead of 9.1 mL) and 2.4 mL of water (instead of 1.17 mL) were used in the initial reaction to form the “initially-formed polyarylate”. The product carboxy-terminated polyarylate had M_{w} of 4140 g/mol.

Examples 3-4 were carried out analogously.

### Example 5

### Sample EA209

To a 250 mL addition funnel was added resorcinol (26 g) and methylene chloride (80 mL). The heterogeneous mixture was degassed for 5 min with nitrogen and triethylamine (TEA, 114 mL) was added cautiously (Caution: This step was slightly exothermic). The mixture was then agitated for several minutes until a homogeneous solution was achieved.

To a reaction vessel equipped as in Example 1 was added iso- and terephthaloyl chloride (189.7 grams of 35% by weight solution of the 1:1 iso/tere mixture in methylene chloride) and methylene chloride solvent (130 mL). To the stirred solution was then added triethylamine (18.2 mL) in methylene chloride (100 mL). The resultant orange solution was stirred for about 1 minute (min.) and then water (2.4 mL) was added in two equal portions at 1 minute intervals. When the color of the resultant solution disappeared (1-2 min.) the resorcinol-TEA solution prepared above was added dropwise via the addition funnel over a period of about 25 minutes. Approximately 120 mL of additional methylene chloride was then added to dilute the reaction mixture. The reaction mixture was then stirred under nitrogen for an additional 50 minutes and an aliquot was removed. A portion of the aliquot was analyzed directly by gel permeation chromatography (GPC), and a portion of this aliquot was subjected to the “Amine Test”. See results in Table 1. Water (300 mL) was added to the reaction vessel to effect the quantitative hydrolysis of the anhydride linkages present in the initially formed polyarylate as in Example 1. The product oligomeric carboxy-terminated polyarylate was isolated and characterized as in Example 1. The product was found to contain about 6% by weight iso- and terephthalic acid. As determined by GPC the product carboxy-terminated polyarylate had a weight average molecular weight (M_{w}) of 3060 grams per mole (g/mol) (Compare with M_{w}=2794 g/mol in the Amine Test). The product was purified (see procedure below) to remove residual iso- and terephthalic acid, and then dried in a vacuum oven at 75° C. for approximately two days prior to its use in a coating formulation.

### Example 6

### Sample EA210

To a 250 mL addition funnel was added resorcinol (23 g) and methylene chloride (84 mL). The heterogeneous mixture was degassed for 5 min with nitrogen and triethylamine (TEA, 114 mL) was added cautiously (Caution: This step was slightly exothermic). The mixture was then agitated for several minutes until a homogeneous solution was achieved.

To a reaction vessel equipped as in Example 1 was added iso- and terephthaloyl chloride (189.7 grams of a 35% by weight solution of the 1:1 iso/tere mixture in methylene chloride) and methylene chloride solvent (236 mL). To the stirred solution was then added triethylamine (18.2 mL) in methylene chloride (80 m/L). The remainder of the procedure was the same as that described in Example 1. The product carboxy-terminated polyarylate had a weight average molecular weight (M_{w}) of 1653 g/mol.

Examples 7-8 were carried out analogously

### Example 9

### (Sample EA213-S) “Soft Block” Containing Carboxy-Terminated Polyarylate

To a 250 mL addition funnel was added resorcinol (18.4 g, 0.167 mole, 0.8 equiv. with respect to total diols), tetraethylene glycol (8.12 g, 0.0418 mol) and methylene chloride (84 mL). The heterogeneous mixture was degassed for 5 minutes with nitrogen, and triethylamine (TEA, 114 mL) was added cautiously (Caution: This step was slightly exothermic). The mixture was then agitated for several minutes until a homogeneous solution was achieved.

A reaction vessel equipped as in Example 1 was charged with iso- and terephthaloyl chloride (189.7 grams of 35% by weight solution of the 1:1 iso/tere mixture in methylene chloride) and methylene chloride solvent (236 mL). The remainder of the experimental was the same as that described in Example 6. The product carboxy-terminated polyarylate comprising tetraethylene glycol derived soft blocks had a weight average molecular weight (M_{w}) of 1754 g/mol.

Example 10 (EA 213-C) was carried out as in Example 9.

Example 11 was carried by analogy to Example 2.

### Example 12

### Sample EA 219

To a one liter addition funnel was added resorcinol (71.3 g) and methylene chloride (260 mL). The heterogeneous mixture was degassed for 5 min with nitrogen and triethylamine (TEA, 353 mL) was added cautiously (Caution: This step was slightly exothermic). The mixture was then agitated for several minutes until a homogeneous solution was achieved.

Into a five liter reaction vessel equipped as in Example 1 was added a mixture of iso- and terephthaloyl chloride (588 g of a 35% by weight solution of the 1:1 iso/tere mixture in methylene chloride) and methylene chloride solvent (740 mL). To the stirred solution was then added triethylamine (62 mL) in methylene chloride (248 mL). The resultant orange solution was stirred for about 1 minute (min.) and then water (7.5 mL) was added in two equal portions at 1 minute intervals. When the color of the solution disappeared (1-2 min) the resorcinol-TEA solution prepared above was added dropwise via the addition funnel over a period of about 25 minutes. The resultant mixture was stirred for a period of about 50 minutes and an aliquot was taken for GPC and the Amine Test. Water (500 mL) was then added to the reaction vessel and the mixture was stirred for approximately 2 hours. The product carboxy-terminated polyarylate was isolated and characterized as in Example 1.

### Example 13

### Sample EA 223

To a container equipped for stirring and operation under an inert atmosphere was added resorcinol (1801.5 g) and methylene chloride (6500 mL). The heterogeneous mixture was degassed for 5 min with nitrogen and triethylamine (TEA, 9 liters) was added cautiously (Caution: This step was slightly exothermic). The mixture was then agitated for several minutes until a homogeneous solution was achieved.

A 50 gallon glass reaction vessel equipped with a condenser, nitrogen inlet, mechanical stirrer and the addition funnel described above, was charged with isophthaloyl chloride (2600 grams), terephthaloyl chloride (2600 grams) and methylene chloride solvent (approx. 20 liters). To the stirred solution was then added triethylamine (1566 mL) in methylene chloride (6265 mL). Water (189 mL) was added in two equal portions at 1 minute intervals with vigorous stirring. When the color of the resultant solution disappeared the resorcinol-TEA solution prepared above was added via an addition tube over a period of about 25 minutes. The reaction mixture was then stirred under nitrogen for an additional 50 minutes and an aliquot was removed. A portion of the aliquot was analyzed directly by gel permeation chromatography (GPC), and a portion of this aliquot was subjected to the “Amine Test”(See description of the Amine Test above). This aliquot which represents the “initially formed polyarylate” (i.e. the polyarylate “before hydrolysis”) had a weight average molecular weight (M_{w}) of 5511 grams per mole and a number average molecular weight (Mₙ) of 2749 grams per mole. After removal of the aliquot, water (32 liters) was added to the reaction vessel and the mixture was stirred for approximately two and half hours at ambient temperature. The stirred reaction mixture was quenched by addition of sufficient 2N H₂SO₄ to bring the pH of the aqueous layer to about 3.4. The product oligomeric carboxy-terminated polyarylate precipitated during the addition of the 2N H₂SO₄. The heterogeneous mixture was then stirred overnight, filtered and the solid product was washed with water until the washings were approximately pH 5. The product was found to contain about 6% by weight iso- and terephthalic acid. As determined by GPC the product carboxy-terminated polyarylate had a weight average molecular weight (M_{w}) of 1854 grams per mole (Compare with M_{w}=1908 grams per mole in the Amine Test).

### Example 14

### Sample EA 202

Example 14 was carried out as in Example 1 with the exception that no water was added to the reaction vessel until after the formation of “initially formed polyarylate” (i.e. no water added until the hydrolysis step). The initially formed polyarylate was characterized as in Example 1 and found to have a weight average molecular weight (M_{w}) of 107216 grams per mole and a number average molecular weight (Mₙ) of 11805 grams per mole. The initially formed polyarylate was hydrolyzed and isolated as in Example 1 and the product carboxy-terminated polyarylate was found to have a weight average molecular weight (M_{w}) of 12418 grams per mole.

Removal of Iso/Terephthalic Acid from Product Carboxy-Terminated Polyarylates

Prior to their use in coating formulations, the product carboxy-terminated polyarylates were freed from iso- and terephthalic acid contaminants using the following procedure. The crude carboxy-terminated polyarylate was dissolved in hot 7:3 chloroform/i-PrOH (volume/volume). The resultant solution was allowed to cool to room temperature and was then washed with an aqueous sodium hydroxide. The organic layer was acidified with aqueous acid to achieve a pH in a range between about pH3 and about pH 4. The product carboxy-terminated polyarylates were then isolated by precipitation into a mixture of methanol and water.

### Examples 15-30 and Comparative Examples 1-3

### Coatings Prepared Using the Carboxy-Terminated Polyarylates

The coatings were applied to two different substrates: (i) AL-2024, 4×6 inch aluminum panels and (ii) CRS-1008, B952 pretreated 4×6 inch steel panels. Both substrates were rinsed with acetone and dried before being coated. These substrates were prefabricated sheets procured from Q-PANEL LAB PRODUCTS INC. (for aluminum) and ACT LABORATORIES INC. (for steel).

The weight percentage of each component used in the formulations for examples 15-30 and Comparative Examples 1-3 along with the property data are shown in Table 2.

Solvent cast coatings were prepared by dissolving the coating components in a suitable solvent, typically dimethylacetamide, to provide a solution containing component A (comprising the carboxy-terminated polyarylate), component B (at least one “organic species” comprising one or more functional groups, said functional groups being chemically reactive with the terminal carboxy groups of the polyarylate of component A) and optionally component C (one or more catalysts which promote chemical reaction between the polyarylate terminal carboxy groups of component A and the chemically reactive functional groups of component B). As noted, although dimethylacetamide was typically employed, other suitable solvents and co-solvents could be employed as well. Suitable solvents and co-solvents include amide solvents such as dimethylformamide, N-methylpyrolidinone (NMP), and the like; esters such as ethyl acetate, butyl acetate, and the like; ketones such as acetone, methyl ethyl ketone, methyl iso-butyl ketone, and the like; alcohols such as methanol, ethanol, and the like; aromatic solvents such as toluene, xylenes, chlorobenzene and the like; halogenated aliphatic solvents such as dichloromethane, chloroform, dichloroethane and the like. It should be noted as well that mixtures solvents and co-solvents may be employed advantageously. The mixture of the coating components and the solvent was then placed on a laboratory roller mixer for at least 10 minutes prior to application of the coating formulation to the substrate in order to ensure thorough mixing of the components and their complete dissolution in the solvent system chosen. If necessary the coating formulation so prepared was heated to about 90° C. to achieve homogeneity.

The formulations were applied manually to the substrates using a 10 mil draw down frame. After application the coating formulation were allowed to stand for a short time under ambient conditions before being cured at the specified temperature and time (See Table 2).

Measurements of Coating Properties

After curing, the coated substrates were allowed to cool to room temperature and were held at ambient temperature and pressure for at least 15 hours before being subjected to the methyl ethyl ketone (MEK) “double rub” test, and the impact tests described in the general experimental section above.

Formulations used to prepare the coatings, coating cure conditions, “double rub” and impact test data are given in Table 2.

In Table 2 with respect to the table headings, “Wt %” indicates the weight percent all non-volatile components of the formulation and does not factor in any solvent present; “Cure Conditions” indicates the conditions of time and temperature under which the coating was cured; “MEK DR” represents the experimental value obtained in the “double rub’ test detailed above; “DI” is the value obtained in the “direct impact test” as measured on the Gardner Impact Tester; and “II” is the value obtained in the “indirect impact test” as measured on the Gardner Impact Tester.

In Table 2 with respect to the “component (A)” listed for each Example, “EA 211” represents a polyarylate having a weight average molecular weight (M_{w}) of about 1652 grams per mole, and comprising structural units having formula I, and further comprising terminal carboxy groups; and “EA 212” represents a polyarylate having a weight average molecular weight (M_{w}) of about 1780 grams per mole, and comprising structural units having formula I, and further comprising terminal carboxy groups. The polyarylates comprising structural units having formula I, and further comprising terminal carboxy groups are also referred to as “acid-capped ITR polymer”.

In Table 2 with respect to the “component (B)” listed for each Example, “TGIC” represents triglycidylisocyanurate (CAS No. 2451-62-9); “FINE CLAD A-229-30-A” (Reichhold Inc.) is a polyacrylate containing glycidyl methacrylate-derived structural units; and “FINE-CLAD A-272” (Reichhold Inc.) is a polyacrylate containing glycidyl methacrylate-derived structural units.

In Table 2 with respect to the “component (C)” listed for each Example, “BTMAB” represents the catalyst benzyltrimethylammonium bromide.

In Table 2, in addition to components (A), (B) and (C) there are listed additional components of the coating formulation. With respect to these additional components which are present but which are neither polyarylates comprising structural units having formula I and further comprising terminal carboxy groups, nor “organic species” comprising one or more functional groups which chemically reactive with said terminal carboxy groups, nor a catalyst which promotes chemical reaction between the polyarylate terminal carboxy groups of component A and the “organic species” of component B; “FLUORAD FC 4430” is a fluorosurfactant (3M Inc.); “FINE-CLAD M8950” is a polyester containing free carboxylic acid groups (Reichhold Inc.) which does not comprise structural units corresponding to formula I, “DDDA” is dodecanedioic acid; “CRYLCOAT 632” is a carboxylic acid functionalized polyester which does not comprise structural units corresponding to formula I (UCB Group); and “CRYLCOAT 7309” is a carboxylic acid functionalized polyester which does not comprise structural units corresponding to formula I (UCB Group).

TABLE 2
EXAMPLE COATINGS OF THE PRESENT INVENTION AND
COMPARATIVE EXAMPLES

| | | | MEK | | |
|---|---|---|---|---|---|
| Example No. (Component) | Wt % | Cure Conditions | DR | DI | II |
| Example 15 | | | | | |
| EA212 (A) | 80.87% | 20 min. at 160° C. | >200 | 40 | 5 |
| TGIC (B) | 16.64% | | | | |
| BTMAB (C) | 1.47% | | | | |
| FLOURAD FC 4430 | 1.02% | | | | |
| Example 16 | | | | | |
| EA212 (A) | 49.42% | 20 min. at 160° C. | >200 | 10 | 0 |
| FINE-CLAD A-229-30-A (B) | 47.86% | | | | |
| BTMAB (C) | 1.51% | | | | |
| FLOURAD FC 4430 | 1.22% | | | | |
| Example 17 | | | | | |
| EA211 (A) | 59.35% | 20 min. at 140° C. | >200 | 20 | 0 |
| FINE-CLAD A-272 (B) | 39.63% | 20 min. at 160° C. | >200 | 30 | 5 |
| FLOURAD FC 4430 | 1.02% | | | | |
| Example 18 | | | | | |
| EA212 (A) | 34.34% | 20 min. at 160° C. | >200 | 60 | 60 |
| CRYLCOAT 632 | 52.16% | | | | |
| TGIC (B) | 10.60% | | | | |
| BTMAB (C) | 1.66% | | | | |
| FLOURAD FC 4430 | 1.24% | | | | |
| Example 19 | | | | | |
| EA212 (A) | 35.09% | 20 min. at 160° C. | >200 | 100 | 80 |
| CRYLCOAT 632 | 52.94% | | | | |
| TGIC (B) | 10.86% | | | | |
| FLOURAD FC 4430 | 1.11% | | | | |
| Example 20 | | | | | |
| EA212 (A) | 27.61% | 20 min. at 160° C. | 92 | 50 | 5 |
| CRYLCOAT 632 | 61.11% | | | | |
| TGIC (B) | 10.28% | | | | |
| FLOURAD FC 4430 | 1.00% | | | | |
| Example 21 | | | | | |
| EA212 (A) | 21.59% | 20 min. at 160° C. | 67 | 80 | 10 |
| CRYLCOAT 632 | 68.32% | | | | |
| TGIC (B) | 9.14% | | | | |
| FLOURAD FC 4430 | 0.95% | | | | |
| Example 22 | | | | | |
| EA211 (A) | 24.89% | 30 min. at 140° C. | 180 | | |
| CRYLCOAT 632 | 36.93% | | | | |
| FINE-CLAD A-229-30-A (B) | 37.18% | | | | |
| FLOURAD FC 4430 | 1.00% | | | | |
| Example 23 | | | | | |
| EA212 (A) | 35.79% | 20 min. at 160° C. | 130 | 160 | 150 |
| CRYLCOAT 7309 | 52.30% | | | | |
| TGIC (B) | 10.77% | | | | |
| FLOURAD FC 4430 | 1.14% | | | | |
| Example 24 | | | | | |
| EA212 (A) | 43.44% | 20 min. at 160° C. | >200 | 160 | 160 |
| CRYLCOAT 7309 | 43.65% | | | | |
| TGIC (B) | 11.87% | | | | |
| FLOURAD FC 4430 | 1.04% | | | | |
| Example 25 | | | | | |
| EA212 (A) | 56.57% | 20 min. at 160° C. | >200 | 160 | 160 |
| CRYLCOAT 7309 | 28.71% | | | | |
| TGIC (B) | 13.60% | | | | |
| FLOURAD FC 4430 | 1.12% | | | | |
| Example 26 | | | | | |
| EA211 (A) | 36.81% | 30 min. at 140° C. | >200 | 140 | <60 |
| CRYLCOAT 7309 | 19.06% | | | | |
| FINE-CLAD A-229-30-A (B) | 43.08% | | | | |
| FLOURAD FC 4430 | 1.06% | | | | |
| Example 27 | | | | | |
| EA 212 (A) | 24.24% | 20 min. at 160° C. | 92 | 160 | 160 |
| FINE-CLAD M 8950 | 65.09% | | | | |
| TGIC (B) | 9.63% | | | | |
| FLOURAD FC 4430 | 1.04% | | | | |
| Example 28 | | | | | |
| EA 212 (A) | 30.55% | 20 min. at 160° C. | 180 | 160 | 160 |
| FINE-CLAD M 8950 | 58.09% | | | | |
| TGIC (B) | 10.37% | | | | |
| FLOURAD FC 4430 | 0.99% | | | | |
| Example 29 | | | | | |
| EA 212 (A) | 38.85% | 20 min. at 160° C. | >200 | 160 | 160 |
| FINE-CLAD M 8950 | 48.86% | | | | |
| TGIC (B) | 11.27% | | | | |
| FLOURAD FC 4430 | 1.01% | | | | |
| Example 30 | | | | | |
| EA211 (A) | 22.09% | 30 min. at 140° C. | 120 | 160 | 160 |
| FINE-CLAD M 8950 | 40.84% | | | | |
| FINE-CLAD A-229-30-A (B) | 36.04% | | | | |
| FLOURAD FC 4430 | 1.02% | | | | |
| Comparative Example 1 | | | | | |
| FINE-CLAD M8950 | 91.6% | 20 min. at 160° C. | 37 | 160 | 160 |
| TGIC (B) | 6.3% | | | | |
| BTMAB (C) | 1.1% | | | | |
| FLUORAD FC 4430 | 1.0% | | | | |
| Comparative Example 2 | | | | | |
| DDDA | 17.81% | 20 min. at 160° C. | 85 | 30 | 0 |
| FINE-CLAD A-229-30-A (B) | 80.37% | | | | |
| BTMAB (C) | 0.78% | | | | |
| FLOURAD FC 4430 | 1.04% | | | | |
| Comparative Example 3 | | | | | |
| DDDA | 25.16% | 20 min. at 140° C. | 20 | 140 | 20 |
| FINE-CLAD A-272 (B) | 73.81% | 20 min. at 160° C. | 80 | 150 | 160 |
| FLOURAD FC 4430 | 1.03% | | | | |

The data in Table 2 for Examples 15-30 reveal the outstanding performance of the coatings of the present relative to the coatings of Comparative Examples 1-3. The MEK double rub results in Table 2 show that formulations containing component A consistently outperform analogous coatings, which do not contain component A (See Comparative Examples). When component A is added to a formulation with moderate solvent resistance the solvent resistance improves dramatically (e.g. compare Comparative Example 1 with Examples 27-30) while retaining an acceptable impact resistance.

### Example 31 illustrates the preparation of a carboxy-terminated oligomeric polyarylate comprising a polycaprolactonediol “Soft Block”.

### Example 31

A first vessel was charged with polycaprolactonediol (“PCLD”, 1542 grams, 2.91 mole) have a measured number average molecular weight (Mₙ) of 530, methylene chloride (1.1 litersY, and triethylamine (“TEA”, 1.6 liters). Caution should be exercised as this mixing is slightly exothermic. The mixture was agitated mechanically until a clear solution was achieved. The solution was degassed for 5 minutes with nitrogen prior to its use. A second vessel was charged with resorcinol (1818 grams, 16.49 mole) and methylene chloride (6.4 liters). The resultant mixture was degassed for 5 minutes with nitrogen and subsequently triethylamine (“TEA”, 9 liters) was cautiously added (exotherm!). The mixture was stirred until clear solution was achieved.

A reaction vessel was charged with isophthaloyl chloride (3087 grams), terephthaloyl chloride (3087 grams) and methylene chloride (28.2 liters) and was stirred under nitrogen until the mixture became homogeneous. A solution of triethylamine (1860 mL) in methylene chloride (7.4 liters) was then added to the solution of the acid chlorides. The resultant mixture was stirred for about 1 minute as color of the mixture changed to orange. Water (225 mL) was then added in two equal portions at 1 minute intervals while the mixture was stirred vigorously. When the orange color of the mixture disappeared (1-2 minutes following completion of the addition of the water) the solution from the first vessel described above was added over a 5 minute period. The resultant mixture was stirred for an additional 10 minute period. This was followed by the addition of the resorcinol-TEA solution from the second vessel over a period of about 20 minutes. When this addition was complete the solution was stirred under nitrogen for an additional 50-60 minutes and a sample was removed for GPC analysis after the sample had been subjected to the “amine test” described above. Subsequently, water (36 liters) was added to the reactor to effect hydrolysis of anhydride linkages. The resultant hydrolysis mixture was stirred until the molecular weight of the product acid-terminated polyarylate comprising the polycaprolactonediol soft block stabilized (after about 4 hours) as measured by GPC at approximately the molecular of the product obtained by subjecting the first sample to the amine test described above. The reaction was then quenched with 2N H₂SO₄ (about 13.5 liters) until the pH of the aqueous phase was about 3. The layers were separated and the organic phase was added to approximately 1.5 volumes of methanol to precipitate the product carboxy-terminated oligomeric polyarylate comprising a polycaprolactonediol “Soft Block”. The product was filtered, washed with water, and dried under vacuum for 48 hours at 45° C. Following drying the product (7 kilograms) was ground and dissolved in hot chloroform/isopropanol (iPrOH) (7:3 vol:vol, 100 liters). The solution was allowed to cool to room temperature and water (80 liters) was added to the reactor. This was followed by the addition of dilute (1% by weight NaOH) sodium hydroxide solution was added in small portions with stirring until the pH of the mixture was in a range between about 5.5 and about 6.0. The mixture was allowed to stand for about 2 hours to effect separation of the organic and aqueous phases. The organic layer was washed once with water and was then stirred and treated while with 1N HCl until the apparent pH of the stirred mixture was about 3. The organic layer was again separated and a portion of the chloroform was evaporated to produce a somewhat more concentrated solution of the product purified carboxy-terminated oligomeric polyarylate comprising a polycaprolactonediol soft block. The product was isolated by precipitation into approximately 5 volumes of a 2:5 mixture of water-methanol mixture. The product was filtered, washed with water, and dried under vacuum at 50° C. for 48 hours. GPC analysis of the product indicated a weight average molecular weight (M_{w}) of 2135 grams per mole relative to polystyrene standards.

The invention has been described in detail with particular reference to preferred embodiments thereof, but it will be understood by those skilled in the art that variations and modifications can be effected within the spirit and scope of the invention.

1. A coating composition comprising components A, B and optionally C
(i) component A comprising at least one polyarylate comprising structural units having formula I 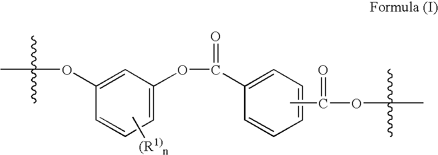
wherein R¹ is independently at each occurrence a C₁-C₁₂ alkyl radical and n is 0-3, said polyarylate further comprising terminal carboxy groups;
(ii) component B comprising at least one “organic species” comprising one or more functional groups, said functional groups being chemically reactive with the terminal carboxy groups of the polyarylate of component A; and optionally
(iii) component C is one or more catalysts which promote chemical reaction between the polyarylate of component A and the “organic species” of component B.

2. The coating composition according to claim 1 wherein the functional groups of component B are selected from the group consisting of isocyanates, epoxies, aliphatic esters, hydroxyl groups, and aromatic esters.

3. The coating composition according to claim 1 further comprising a co-resin.

4. The coating composition according to claim 1 wherein the concentration of component A is at about 1 to about 99 percent by weight of the total weight of the coating composition.

5. The coating composition according to claim 1 wherein the concentration of component B is at about 99 to about 1 percent by weight of the total weight of the coating composition.

6. The coating composition according to claim 1 wherein the concentration of component C is at about 0.00001 to about 10 percent by weight of the total weight of the coating composition.

7. The coating composition according to claim 1 wherein component A further comprises structural units having formula VIII: 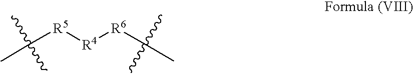
wherein R⁴ is a C₂-C₁₀₀₀₀ aliphatic radial, or a C₄-C₂₀ cycloaliphatic radical and R⁵ and R⁶ each independently represent a bond

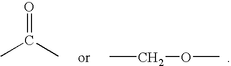

8. The coating composition according to claim 7 wherein said C₂-C₁₀₀₀₀ aliphatic radical R⁴ comprises structural units having formula IX

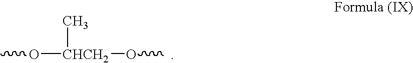

9. The coating composition according to claim 7 wherein said C₂-C₁₀₀₀₀ aliphatic radical R⁴ comprises structural units having formula X

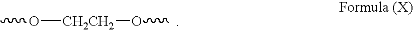

10. The coating composition according to claim 7 wherein the concentration of the structural unit of formula VIII in component A is in a range between about 0.01 to about 50 percent by weight of the total weight of the coating composition.

11. The coating composition according to claim 1 wherein said polyarylate has a number average molecular weight in a range between about 2000 and about 5000 grams per mole.

12. The coating composition according to claim 1 wherein said polyarylate has a number average molecular weight in a range between about 500 and about 2500 grams per mole.

13. The coating composition according to claim 1 wherein the catalyst is selected from the group consisting of tertiary amines, quaternary ammonium salts, quaternary phosphonium salts, Lewis acids, and mixtures thereof.

14. The coating composition according to claim 1 further comprising at least one solvent.

15. The coating composition according to claim 14 wherein said solvent is selected from the group consisting of amides, esters, ethers, ketones, alcohols, aromatics, halogenated solvents and mixtures thereof.

16. The coating composition according to claim 15 wherein said solvent is selected from the group consisting of dimethylacetamide, tetrahydrofuran, and mixtures thereof.

17. The coating composition according to claim 1 further comprising water.

18. The coating composition according to claim 18, said coating composition being a dispersion in water.

19. The coating composition according to claim 1 further comprising at least one additive selected from the group consisting of inorganic pigments, organic pigments, inorganic fillers, UV screeners, stabilizers, degassing agents, flow aid agents, surfactants, hindered amine light stabilizers (HALS), surface tension modifying agents, viscosity modifying agents, and organic fillers.

20. A powder coating composition comprising components A, B and optionally C (i) component A comprising at least one polyarylate comprising structural units having formula I 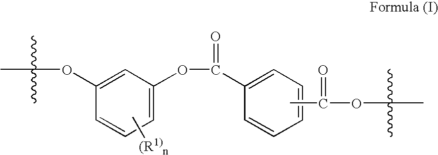
wherein R¹ is independently at each occurrence a C₁-C₁₂ alkyl radical and n is 0-3, said polyarylate further comprising terminal carboxy groups;
(ii) component B comprising at least one “organic species” comprising one or more functional groups, said functional groups being chemically reactive with the terminal carboxy groups of the oligomeric polyarylate of component A; and optionally
(iii) component C one or more catalysts which promote chemical reaction between the polyarylate of component A and the “organic species” of component B.

21. The powder coating composition according to claim 20 wherein the functional groups of component B are selected from the group consisting of isocyanates, blocked isocyanates, epoxies, aliphatic esters, hydroxyl groups, and aromatic esters.

22. The powder coating composition according to claim 20 further comprising a co-resin.

23. The powder coating composition according to claim 20 wherein the concentration of component A is at about 1 to about 99 percent by weight of the total weight of the powder coating composition.

24. The powder coating composition according to claim 20 wherein the concentration of component B is at about 99 to about 1 percent by weight of the total weight of the powder coating composition.

25. The powder coating composition according to claim 20 wherein the concentration of component C is at about 0.0001 to about 10 percent by weight of the total weight of the powder coating composition.

26. The powder coating composition according to claim 20 wherein component A further comprises structural units having formula VIII: 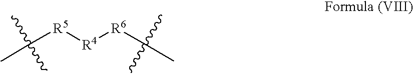
wherein R⁴ a C₂-C₁₀₀₀₀ aliphatic radial, or a C₄-C₂₀ cycloaliphatic radical and R⁵ and R⁶ each independently represent a bond,

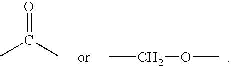

27. The powder coating composition according to claim 26 wherein said C₂-C₁₀₀₀₀ aliphatic radical R⁴ comprises structural units having formula IX

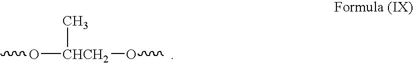

28. The powder coating composition according to claim 26 wherein said C₂-C₁₀₀₀₀ aliphatic radical R⁴ comprises structural units having formula X:

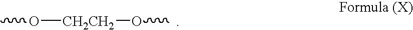

29. The powder coating composition according to claim 26 wherein the concentration of the structural unit of formula VIII in component A is in a range between about 0.01 to about 50 percent by weight of the total weight of the powder coating.

30. The powder coating composition according to claim 20 wherein said polyarylate is a polyarylate oligomer having a number average molecular weight in a range between about 2000 and about 5000 grams per mole.

31. The powder coating composition according to claim 20 wherein said polyarylate is a polyarylate oligomer having a number average molecular weight in a range between about 500 and about 2500 grams per mole.

32. The powder coating composition according to claim 30 wherein said oligomeric polyarylate is amorphous.

33. The powder coating composition according to claim 30 wherein said oligomeric polyarylate is a crystalline solid.

34. The powder coating composition according to claim 20 wherein the catalyst is selected from the group consisting of tertiary amines, quaternary ammonium salts, quaternary phosphonium salts, Lewis acids, and mixtures thereof.

35. A method of making a polyarylate comprising structural units derived from at least one dihydroxy-substituted aromatic hydrocarbon and at least one aromatic dicarboxylic acid dichloride, said polyarylate further comprising terminal carboxy groups, said method comprising the steps of:
(a) combining at least one dihydroxy-substituted aromatic hydrocarbon moiety and optionally one or more dihydroxy-substituted aliphatic moieties, and at least one organic base in an inert organic solvent to form a mixture, said dihydroxy-substituted aromatic hydrocarbon moiety being substantially soluble in said mixture, said dihydroxy-substituted aromatic hydrocarbon and said optional dihydroxy-substituted aliphatic moiety being used in a molar amount;
(b) combining the mixture formed in step (a) with at least one dicarboxylic acid dichloride in a molar amount such that the molar amount of the dihydroxy-substituted aromatic hydrocarbon and optional dihydroxy-substituted aliphatic moiety in the mixture is stoichiometrically deficient relative to the total molar amount of dicarboxylic acid dichloride, to form a reaction mixture;
(c) agitating the reaction mixture formed in step (b) in the presence of an amount of water sufficient to provide at least one anhydride linkage, to form a polyarylate comprising at least one anhydride linkage; and
(d) hydrolyzing the polyarylate formed in step (c) to provide a product polyarylate comprising terminal carboxy groups, said product polyarylate being essentially free of terminal hydroxy groups.

36. A method according to claim 35 wherein said dihydroxy-substituted aromatic hydrocarbon moiety comprises structure V 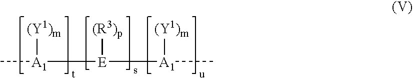
wherein A₁ is independently an aromatic group; E is alkylene, alkylidene, or cycloaliphatic group; a sulfur-containing linkage; a phosphorus-containing linkage; an ether linkage; a carbonyl group; a tertiary amino linkage; or a silicon-containing linkage; R³ is independently at each occurrence a monovalent hydrocarbon group; Y¹ is independently at each occurrence a monovalent hydrocarbon group, halogen, and nitro; “mi” represents any integer from and including zero through the number of positions on A1 available for substitution; “p” represents an integer from and including zero through the number of positions on E available for substitution; “t” represents an integer equal to at least one; “s” is either zero or one; and “u” represents any integer including zero.

37. A method according to claim 35 wherein said dicarboxylic acid dichloride is selected from the group consisting of monocyclic dicarboxylic acid dichlorides and polycyclic aromatic dicarboxylic acid dichlorides.

38. A method according to claim 35 wherein said dicarboxylic acid dichloride is selected from the group consisting of isophthaloyl dichloride, terephthaloyl dichloride, mixtures of isophthaloyl and terephthaloyl dichlorides, diphenyl dicarboxylic acid dichloride, diphenylether dicarboxylic acid dichloride, and naphthalene-2,6-dicarboxylic acid dichloride.

39. A method according to claim 35 wherein the organic base is at least one tertiary amine.

40. The method according to claim 39 wherein said tertiary amine is selected from the group consisting of triethylamine, tributylamine; N,N-dimethyl-N-butylamine; N,N-diisopropyl-N-ethylamine; N-ethylpiperidine, N-methylpiperidine, N-methylmorpholine, N,N-dimethyldecylamine; N,N-dimethyloctadecylamine; 2,2,6,6-tetramethylpiperidine, and diazabicylco[2.2.2]octane.

41. A method according to claim 35 wherein the organic base is present in an amount corresponding to about 0.9 to about 10 equivalents with respect to the acid chloride moiety.

42. A method according to claim 35 wherein said at least one of the dicarboxylic acid dichloride or the optional dihydroxy-substituted aliphatic moiety comprises “soft block” structural units having formula VIII: 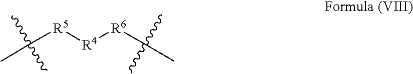
wherein R⁴ a C₂-C₁₀₀₀₀ aliphatic radial, or a C₄-C₂₀ cycloaliphatic radical and R⁵ and R⁶ each independently represent a bond,

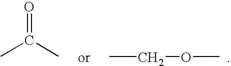

43. A method according to claim 42 wherein said dihydroxy-substituted aliphatic moiety is polycaprolactone diol.

44. A method of making an oligomeric polyarylate comprising structural units having formula I 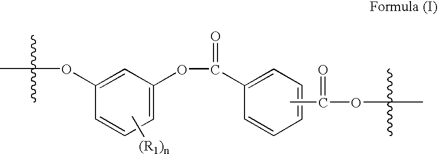
wherein R¹ is independently at each occurrence a C₁-C₁₂ alkyl radical and n is 0-3, said polyarylate further comprising terminal carboxy groups, said method comprising the steps of:
(a) combining at least one resorcinol moiety and optionally one or more dihydroxy-substituted aliphatic moieties, and at least one organic base in an inert organic solvent to form a mixture, said resorcinol moiety being substantially soluble in said mixture, said resorcinol moiety and optional dihydroxy-substituted aliphatic moiety being used in an amount corresponding to a total molar amount of resorcinol moiety and optional dihydroxy-substituted aliphatic moiety;
(b) combining the mixture formed in step (a) with at least one dicarboxylic acid dichloride in a molar amount such that the total molar amount of resorcinol moiety and optional dihydroxy-substituted aliphatic moiety in the mixture is stoichiometrically deficient relative to the molar amount of dicarboxylic acid dichloride to form a reaction mixture;
(c) agitating the reaction mixture formed in step (b) in the presence of an amount of water sufficient to provide at least one anhydride linkage, to form a polyarylate comprising at least one anhydride linkage; and
(d) hydrolyzing the polyarylate formed in step (c) to provide a product polyarylate comprising terminal carboxy groups, said product polyarylate being essentially free of terminal hydroxy groups.

45. The method of making an oligomeric polyarylate according to claim 44 wherein said at least one resorcinol moiety is selected from the group consisting of unsubstituted resorcinol, 2-methyl resorcinol and mixtures thereof.

46. The method of making an oligomeric polyarylate according to claim 45 wherein said at least one resorcinol moiety is an unsubstituted resorcinol.

47. The method of making an oligomeric polyarylate according to claim 44 wherein the organic base is present in an amount corresponding to about 0.9 to about 10 equivalents with respect to the dicarboxylic acid dichloride moiety.

48. The method of making an oligomeric polyarylate according to claim 47 wherein the organic base comprises at least one tertiary amine.

49. The method of making an oligomeric polyarylate according to claim 48 wherein said tertiary amine is selected from the group consisting of triethylamine, tributylamine; N,N-dimethyl-N-butylamine; N,N-diisopropyl-N-ethylamine; N-ethylpiperidine, N-methylpiperidine, N-methylmorpholine, N,N-dimethyldecylamine; N,N-dimethyloctadecylamine; 2,2,6,6-tetramethylpiperidine, and diazabicylco[2.2.2]octane.

50. The method of making an oligomeric polyarylate according to claim 44 wherein at least one dicarboxylic acid dichloride is naphthalene-2,6-dicarboxylic acid dichloride.

51. The method of making an oligomeric polyarylate according to claim 44 wherein the dicarboxylic acid dichloride is a mixture of isophthaloyl dichloride and terephthaloyl dichloride.

52. The method of making an oligomeric polyarylate according to claim 51 wherein said mixture has a molar ratio of isophthaloyl dichloride to terephthaloyl dichloride in a range between about 0.2:1 and about 5:1.

53. The method of making an oligomeric polyarylate according to claim 52 wherein the molar ratio of isophthaloyl dichloride to terephthaloyl dichloride is in a range between about 0.8:1 and about 2.5:1.

54. The method of making an oligomeric polyarylate according to claim 44 wherein the organic solvent is selected from the group consisting of chloroform, chlorobenzene, toluene, methylene chloride, 1,2-dichloroethane, dichlorobenzene, xylene, trimethylbenzene, and mixtures thereof.

55. The method of making an oligomeric polyarylate according to claim 44 wherein either or both of said dicarboxylic acid dichloride and dihydroxy aliphatic moiety comprises “soft block” structural units having formula VIII: 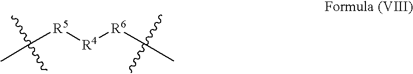
wherein R⁴ a C₂-C₁₀₀₀₀ aliphatic radial, or a C₄-C₂₀ cycloaliphatic radical and R⁵ and R⁶ each independently represent a bond,

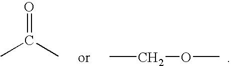

56. The method of making an oligomeric polyarylate according to claim 55 wherein said dicarboxylic acid dichloride or dihydroxy aliphatic moiety comprising “soft block” structural units having formula VIII is used in an amount sufficient to provide a concentration of the “soft block” having formula VIII in the product oligomeric polyarylate in a range between about 0.01 and about 70% by weight.

57. A coated article comprising:
a substrate layer comprising at least one thermoplastic polymer, thermoset polymer, a cellulosic material, glass or metal, and
at least one cured coating layer thereon, said coating comprising the cure-reaction products of components A, B and C:
(i) component A comprising at least one oligomeric polyarylate, said polyarylate comprising structural units having formula I 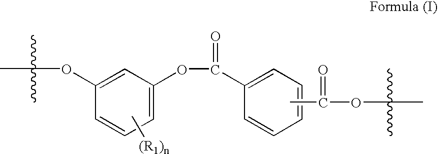
wherein R¹ is independently at each occurrence a C₁-C₁₂ alkyl radical and n is 0-3, said oligomeric polyarylate further comprising terminal carboxy groups;
(ii) component B comprising at least one “organic species” comprising one or more functional groups, said functional groups being chemically reactive with the reactive hydroxy terminal groups of the oligomeric polyarylate of component A; and
(iii) at least one catalyst which promotes the reaction between the oligomeric polyarylate of component A and the “organic species” of component B.

58. The coated article according to claim 57 wherein the coating further comprises a co-resin.

59. The coated article according to claim 57 wherein component A further comprises structural units having formula VIII: 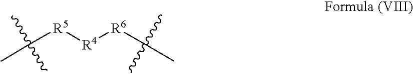
wherein R⁴ a C₂-C₁₀₀₀₀ aliphatic radial, or a C₄-C₂₀ cycloaliphatic radical and R⁵ and R⁶ each independently represent a bond,

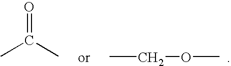

60. A carboxy-terminated polyarylate comprising structural units having formula I 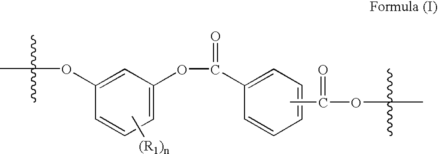
wherein R¹ is independently at each occurrence a C₁-C₁₂ alkyl radical and n is 0-3.

61. The carboxy-terminated polyarylate of claim 60 having a weight average molecular weight in a range between about 500 and about 14000 grams per mole as determined by gel permeation chromatography using polystyrene molecular weight standards.

62. An anhydride-containing polyarylate comprising structural units having formula I 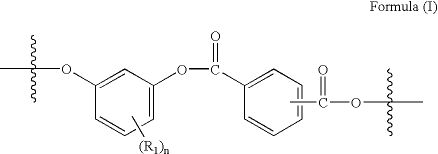
wherein R₁ is independently at each occurrence a C₁-C₁₂ alkyl radical and n is 0-3, said anhydride-containing polyarylate comprising between about 0.001 and about 15 weight percent anhydride moieties based on the weight of the anhydride-containing polyarylate.

63. The anhydride-containing polyarylate of claim 62 having a weight average molecular weight (M_{w}) of less than about 10000 grams per mole as determined by gel permeation chromatography using polystyrene molecular weight standards.
